(19) United States
(12) Patent Application Publication
(10) Pub. No.: US 2014/0284271 A1
(43) Pub. Date: Sep. 25, 2014

(54) PHOTOBIOREACTOR SYSTEM AND METHOD OF USING THE SAME

(71) Applicant: Algaeon, Inc., Indianapolis, IN (US)

(72) Inventors: William R. Kassebaum, Indianapolis, IN (US); John A. Kassebaum, Indianapolis, IN (US); Tony Allen Gibbens, Greenwood, IN (US)

(73) Assignee: Algaeon, Inc., Indianapolis, IN (US)

(21) Appl. No.: 14/226,129

(22) Filed: Mar. 26, 2014

Related U.S. Application Data
(63) Continuation-in-part of application No. 12/916,572, filed on Oct. 31, 2010, now Pat. No. 8,722,396.

(51) Int. Cl. C02F 3/32

(52) U.S. Cl. CPC C02F 3/322
USPC 210/602; 210/198.1; 210/96.1

(57) ABSTRACT

A photobioreactor assembly, including panel having an array of equal radius, generally parallel, generally vertical and generally transparent tubes, where the tubes have a radius such that for a pre-determined microorganism preferred light intensity level, photosynthesis viable light is available at the center of each tube for an expected maximum culture density for that microorganism, an air supply operationally connected to panel and capable of maintaining a positive pressure within the panel, a water purifier operationally connected to the panel, and a water supply operationally connected to the water purifier. Each respective tube is connected in fluidic communication with each other.

### CROSS-REFERENCE TO RELATED APPLICATIONS

This application claims priority to co-pending U.S. patent application Ser. No. 12/916,572, filed on Oct. 31, 2010.

### TECHNICAL FIELD

The present novel technology relates generally to the field of energy, and, more particularly, to bioreactors for efficiently growing, cultivating and harvesting algae and their useful fuel oils in a phototrophic algae production process.

### BACKGROUND

Due to dwindling supplies coupled with increasing demand, the price of oil has, and will continue to increase substantially over the years. The increasing price of oil, along with an increased scrutiny on the effects of greenhouse gas emissions, has led to the evaluation of alternative fuel sources to meet the energy demands and address environmental concerns. One such alternative fuel is the production of crude oil and biodiesel from vegetative precursors, such as algae.

A principal component of algae's composition is lipid oil which can be converted into a crude-type oil, consisting primarily of single-chain hydrocarbons or triglyceride and di-glyceride fats and oils, for biodiesel feedstock. Algae has the benefit of being able to be grown in massive quantities with very little environmental impact. All that is needed to grow algae is water, appropriate nutrients, sunlight and carbon dioxide. Thus, as compared to petroleum, oil and biodiesel produced from algae are not a limited resource, because algae can be continuously grown in mass quantities for fuel production. Moreover, as compared to food crop biodiesel and ethanol produced from feed crops (i.e., grains), the production of algae does not drive up the price of certain food products and has a higher level of efficiency. For example, soy or corn yields approximately 70-100 and 150-300 gallons of fuel per acre per year, respectively. In contrast, certain algae species can yield in excess of 10,000 gallons of fuel per acre per year.

In addition, algae can provide several other benefits. For example, algae can yield specialty chemicals and/or pharmaceuticals (i.e., plastic resins (such as PHA and PHB), ketones, acetone, beta-carotene and Omega-3 and the like), nutrients, and a food source for animals, fish and humans. The challenge for producers of algae is not only to identify the most efficient strains of algae to use for the desired end-product, but also to determine how algae best can be grown to meet the demand for such end-products.

The most natural system for growing algae is the open-pond system (e.g., raceway ponds or natural ponds). Open-pond systems allow for algae growth in its natural environment and minimize environmental impact. While an open-pond system offers a low-cost algae production environment with very little environmental impact, open-pond systems inherently present too many variables to be controlled for maximized algae production. For example, open-pond systems are more susceptible to contamination from bacteria or other organisms that can stunt algae growth and make it difficult to target desired species of algae. Further, algae need to be shielded from bad weather and the water needs to be adequately stirred to promote algae growth, which is difficult and expensive to control in open-pond systems. As a result of all of these variables, open-pond systems suffer from low and/or inconsistent productivity levels.

In attempts to maximize yield and increase the speed of algae production, algae producers have utilized photoautotrophic and heterotrophic methods of algae production. Photoautotrophic methods utilize light to produce biomass, while heterotrophic methods involve algae consumption of sugars to produce biomass. Photoautotrophic algae producers use closed-loop systems, such as bioreactors or closed tank systems. Bioreactors involve the use of an array of vessels, typically bags or tubes, filled with an algae culture and media to maximize sun exposure and algae production. Closed tank systems involve the use of round drums and a controlled environment to maximize algae production. Heterotrophic systems, such as fermentation systems, are also being tested and developed in attempts to maximize the production of algae. The problems with all of these systems to date is that they each suffer from extremely high production costs that are so cost prohibitive that only small scale uses of these systems are economically feasible.

For photoautotrophic algae production methods, the focus is on optimizing photosynthesis to promote algae growth. Plants derive energy from sunlight and use that energy to convert carbon dioxide and water into biomass. Uncultivated macroscopic green plants have an energy utilization efficiency of approximately 0.2% (i.e., 0.2% of incident sunlight is utilized by the plant to convert water and carbon dioxide into biomass). Plants species can be classified by referring to their carbon fixation process (e.g., C₃-cycle plant species and C₄-cycle plant species), which is the first step of converting sunlight to biomass in photosynthetic organisms. Plant cultivation can improve energy utilization to a range of 1-2% for C₃-cycle plant species and up to about 8% for the most productive C₄-cycle plant species (e.g., sugarcane). Uncultivated microscopic green algae (typically C3-cycle plants) are more efficient than macroscopic plant species and can average as much as 6.2% energy utilization efficiency. Thus, by cultivating algae in controlled environments, the energy utilization efficiency can be increased even more and the rates for growing algae can substantially be increased.

Algae grows best at low light levels because at low light levels, algae photoefficiency can be as high as 60% to 80%. Counter-intuitively, high light levels decrease production, because algae respond to high light levels by protecting themselves from excessive radiation through the mechanisms of photoinhibition and photorespiration. Photoinhibition is the production of light absorbing materials to protect the algae's light harvesting chlorophyll antennas from damage caused by light over-saturation. Photorespiration essentially short-circuits the photosynthesis process because of excess production of oxygen. The result is that oxygen out-competes carbon dioxide at the site of the Rubisco enzyme and glucose cannot be produced. Thus, to keep algae biomass production occurring at a high rate, the light levels must be low enough so that carbon fixation does not exceed the concentration dependent diffusion rates of carbon dioxide into the algae's chloroplasts.

It also needs to be kept in mind that photosynthesis does not use a large proportion of the sun's broad light production. Even though the sun has its highest output in the green portion of the spectrum (around 550 nm), algae only use the light in portions of the red and blue regions of the spectrum. The inactive portions of the spectrum, such as ultraviolet and infrared portions, contain quite a bit of energy which constitutes a large fraction of the solar output. Unfortunately, these inactive portions often cause more harm than good in the algae growing process because ultraviolet radiation can cause damage and resulting oxidative stress. Infrared radiation can also cause significant and potentially damaging over-heating of the algae.

To prevent the problems associated with over radiation, algae producers can use some means of shifting the sun's illumination to match the photosynthetic action spectra. Such tools can involve the use of light sources, such as highly efficient blue and red LEDs, that effectively and efficiently produce photosynthetically active radiation (PAR). However, the use of such light sources have the negative impact of increasing the cost of production because they increase the amount of energy needed to power the production process.

Thus, a photobioreactor system and method for producing algae is still needed that optimizes the available sunlight and maximizes the production of algae in a low-cost, efficient manner in order to make large scale algae production economically feasible. The present novel technology addresses this need.

### BRIEF DESCRIPTION OF THE DRAWINGS

The features and advantages of this disclosure, and the manner of attaining them, will be more apparent and better understood by reference to the following descriptions of the disclosed system and method, taken in conjunction with the accompanying drawings, wherein:

FIG. 1 is a perspective view of a first embodiment photobioreactor system according to the present disclosure.

FIG. 2 is a front elevation view of an array of elongated reaction tubes used in the photobioreactor system of FIG. 1.

FIG. 3A is an enlarged partial perspective view of the lower manifold of FIG. 1.

FIG. 3B is an enlarged partial perspective view of the upper manifold of the photobioreactor system of FIG. 1.

FIG. 4 is an enlarged partial perspective view of a relief valve from the photobioreactor systems of FIG. 1.

FIG. 5A is a perspective view of the arrays of a photobioreactor system according to the embodiment of FIG. 1.

FIG. 5B is an enlarged partial view of FIG. 5A showing a purifier system.

FIG. 6 is a partial perspective view of the lower manifold and air inlet of the embodiment of FIG. 1.

FIG. 7 is an enlarged partial perspective view of the algae outlet of the system of FIG. 1.

FIG. 8A is a perspective view of a second embodiment photobioreactor system of the present invention.

FIG. 8B is an enlarged partial view of FIG. 8A.

FIG. 9A is a sectional view of the photobioreactor system of FIG. 8A.

FIG. 9B is a sectional view of the photobioreactor system of FIG. 8B.

FIG. 10 is a schematic view of the embodiments of FIGS. 1 and 8A.

FIG. 11A provides a schematic view of an exemplary novel fluidized bed for biological filtration as part of a photobioreactor such as described in this application.

FIG. 11B provides a sectional view of an exemplary novel fluidized bed for biological filtration as part of a photobioreactor such as described in this application.

### DETAILED DESCRIPTION

For the purposes of promoting an understanding of the principles of the present disclosure, reference will now be made to the embodiments illustrated in the figures, and specific language will be used to describe the same. It will nevertheless be understood that no limitation of the scope of this disclosure is thereby intended.

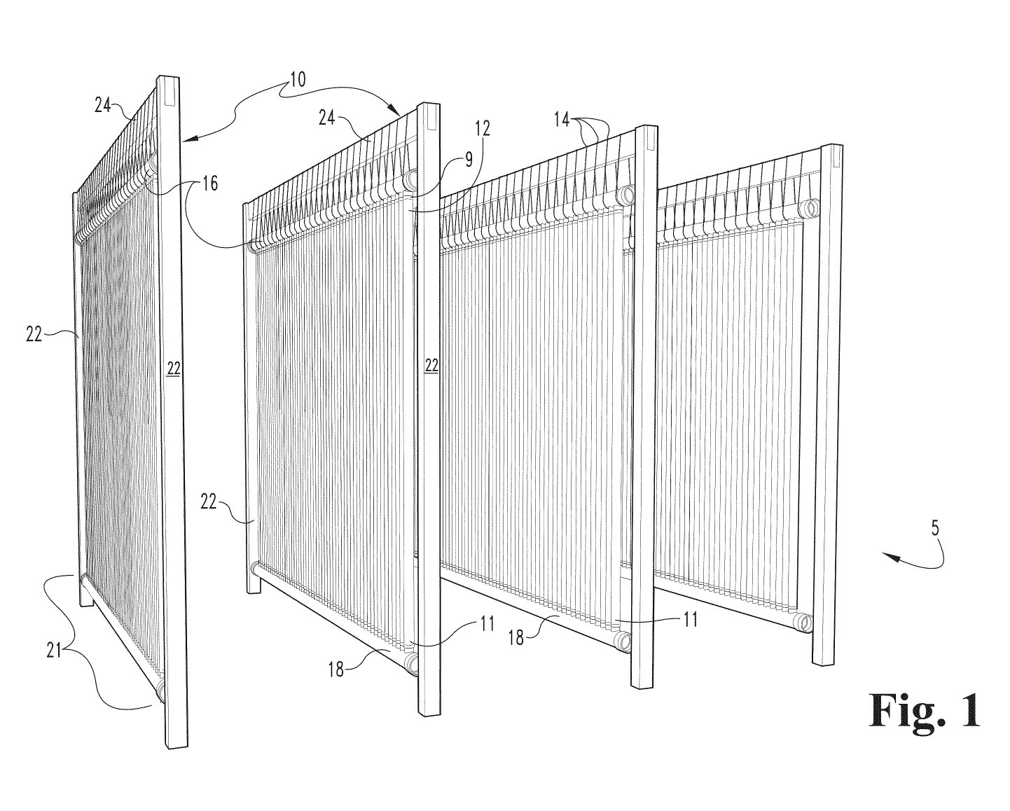

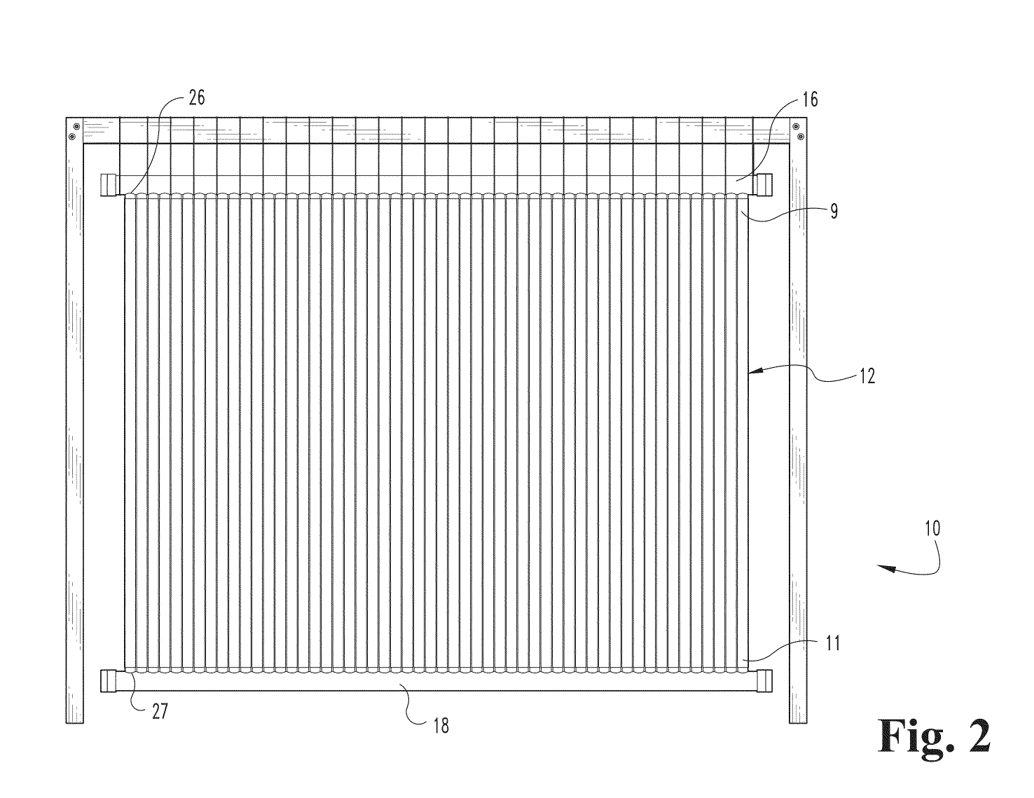

FIGS. 1-7 and 10 illustrate a first embodiment photobioreactor system 5 for the mass production of algae in an efficient and cost effective manner. As shown in FIG. 1, photobioreactor system 5 includes one or more arrays 10 of vertically arranged vessels or tubes 12, each respective tube 12 attached at its top end 9 to top manifold 16 and at its lower end 11 to bottom manifold 18. Each manifold typically comprises a generally rigid pipe with a plurality of generally cylindrical openings 26, 27 (shown in FIG. 2). The openings 26, 27 are typically evenly spaced and may be raised to engage the tube ends 9, 11. In this embodiment, such pipes are polyvinyl chloride (PVC) pipes, but it should be understood that any type of pipe material may be selected.

Still referring to FIG. 1, photobioreactor system 5 is attached to a frame 21 that comprises two vertical beams 22 and a top rail 24. In this embodiment, top rail 24 and vertical beams 22 are made of wood. While vertical beams 22 and top rail 24 are made of wood in this embodiment, it will be appreciated that any other structural material that is of sufficient strength to hold photobioreactor system 5 can be used to construct the frame. Typically, vertical beams 22 are anchored into the ground by cement, but it will be appreciated that vertical beams 22 could be mounted to a base or anchored to the ground in any number of ways known to those skilled in the art. Top rail 24 is attached to vertical beams 22 by any suitable attachment means, including, but not limited to, nails, bolts, or screws. Each end of the top rail 24 is attached at the top end of both vertical beams 22 to form the rectangular frame depicted in FIG. 1. Top manifold 16 may be attached to top rail 24 utilizing any number of attachment means known in the art. As shown in FIGS. 1-3, top manifold 16 is connected to top rail 24 by a plurality of wire riggings 14 that are wrapped around both top manifold 16 and top rail 24.

Referring to FIGS. 1 and 2, tubes 12 each define an individual cellular bioreactor and are typically each arranged vertically along the photobioreactor system's 5 vertical, Y-axis. Tubes 12 have a similar structure as a pipe in that each tube 12 is a hollow, generally cylindrical body. Prior art tubular bioreactors had the drawback of being constructed from solid or inflexible pipe materials, such as glass, acrylic, polycarbonate, transparent PVC, and other similar materials. The cost of such materials is expensive and has prevented tubular bioreactors from being used on larger scales. Tubes 12 of the photobioreactor system 5 are each produced from thin, inexpensive films. The tubes 12 are typically transparent (e.g., at least 90% transmissive) to allow for sunlight to enter into the tube 12. Tubes 12 are typically opaque to UV radiation, so that the tubes 12 will not degrade quickly and will not expose algae to unwanted UV. Tubes 12 typically have tensile strength at the operational temperatures of the photobioreactor system 5 sufficient to oppose the pressure of the tube 12 being filled with fluid and typically have sufficient toughness to resist tearing or rupturing when punctured, so that the tube 12 can be easily patched if a leak occurs.

Low density polyethylene (LDPE) plastic films are well suited to form each tube 12. Tubes 12 constructed from such plastic films have a useful stretching property. As such films elongate along the axial direction, the film will contract tangentially and radially. As a result, when tubes 12 are filled with liquid, the tubes 12 do not form a tear-drop shape or ‘pillow-out’ at the bottom, but instead, typically remain cylindrical along their entire length. LDPE films are also effective because they can be made to be resistant to UV rays and normally have a life-cycle in excess of four years when used outdoors.

In addition to LDPE films, it will be appreciated by those skilled in the art that other films with similar characteristics to LDPE films can be used to create tubes 12. Examples of other film materials that can be used include ethylene tetrafluoride (ETFE, a form of Teflon), polyethylene terephalate (PET), and vinyl films. ETFE films are another useful film because they are optically clear, durable, and highly radiation resistant with a life-cycle of 20 to 50 years when used outside. PET films have been found to be susceptible to tearing and if used, are typically reinforced or layered with another plastic to avoid tearing.

By selecting films with sufficient tensile strength at the photobioreactor system's 10 operating temperatures, the amount of plastic resin required may be substantially reduced to yield substantial cost savings. For example, LDPE and ETFE films can be used at thicknesses as low as 2 mils to create tubes 12, which still have sufficient tensile strength to hold a 15 foot high column of fluid with little difficulty. While LDPE and ETFE films can be used as low as 2 mils in thickness, the LDPE and ETFE films typically have a thickness of a least 6 mils such that resultant tubes 12 are more durable and easier to handle without resulting in damage during the algae production process.

Furthermore, the plastic resin can be impregnated with various substances to impart various desirable effects into the plastic resin. For example, substances can be introduced into the plastic resin such that the plastic film maintains an oil-phobic or oil-repellant surface such that oil-rich microorganisms are less likely to adhere to the plastic film. As another example, compounds having antimicrobial properties, generally referred to as biocides, may be introduced into the plastic resin to inhibit the growth of undesirable organisms or agents such as bacteria, fungi, viruses, phages, and the like. For example, an antibiotic compound can be introduced into the plastic resin such that the plastic film helps to prevent the growth of undesirable bacteria on the surface of the plastic film and/or within the growth medium.

Such impregnations to the plastic resin can be done such that heat labile compounds, such as heat labile antimicrobial compounds, are not damaged. For example, a catalyst capable of polymerization of a chosen monomer can be used to polymerize the monomer at temperatures not harmful to the heat labile compounds. As another example a carrier material to serve as a carrier for a heat labile compound can be used to introduce and prevent the volatization, decomposition, or chemical reaction of the heat labile compound during the polymerization of the chosen monomer. The immediately following is provided as a more complete example of accomplishing impregnation of a compound into a plastic resin through the first exemplary method. It is nonetheless understood that other methods of achieving a polymer impregnated with one or more compounds are similarly suited for this purpose and are known to those reasonably skilled in the art.

As an example, a catalyst can be used for a chosen plastic resin such that polymerization occurs at a temperature nonharmful or nondestructive to the chosen impregnating compound. One such example is an azo compound identified as 2,2′-azobis-(2,4-dimethylvaleronitrile) and marketed by E. I. du Pont de Nemours & Company (DuPont) under the trademark Vazo 52. The preferred range of this catalyst has been from about 0.1-1.0% by weight of the total co-monomer components used. It is nonetheless understood that other catalysts within these groups are similarly suited for this purpose and are within the scope of the invention. Catalyst choice can be made in view of the catalyst's initiation temperature and the stability of the polymers constituents. Peroxide catalysts and/or redox catalyst systems providing an appropriate initiation temperature can also be used.

Potential example monomers use include, but are not limited to styrene, substituted styrenes, acrylic acid, acrylates, vinylpyridines, and the like, and can be selected based on the desired properties and the ability to catalyze the polymerization under the desired reaction conditions. Methods for carrying out the polymerizations can include, but are not limited to suspension polymerization, bulk polymerization, injection molding, blow molding and the like. The monomer mixture can be polymerized by subjecting the monomer mixture to temperatures sufficient to initiate polymerization. For the Vazo 52 catalyst, the polymerization temperature is in the order of about 50 degrees centigrade or higher. In addition, the monomer mixture can contain a cross-linking agent such as divinylbenzene or other difunctional cross-linking agents in amounts ranging typically from about 0.1 to 15% or higher.

Examples of compounds suitable to impregnate the polymer may include biocides, quaternary amines, and antibiotics. For example suitable biocides include but are not limited to: Acetylcarnitine, Acetylcholine, Aclidinium bromide, Acriavinium chloride, Agelasine, Aliquat 336, Ambenonium chloride, Ambutonium bromide, Aminosteroid, Anilinium chloride, Atracurium besilate, BenZalkonium chloride, Benzethonium chloride, Benzilone, Benzododecinium bromide, Benzoxonium chloride, Benzyltrimethylammonium fluoride, BenZyltrimethylammonium hydroxide, Bephenium hydroxynaphthoate, Berberine, Betaine, Bethanechol, Bevonium, Bibenzonium bromide, Bretylium, Candocuronium iodide, Carbachol, Carbethopendecinium bromide, Carnitine, Cetrimonium, Cetrimonium bromide, Cetylpyridinium chloride, Chelerythrine, Chlorisondamine, Choline, Choline chloride, Cimetropium bromide, Cisatracu, Demecarium bromide, Denatonium, Dequalinium, Didecyldimethylammonium chloride, Dimethyldioctadecy lammonium chloride, DimethylphenylpiperaZinium, DiOC6, Diphemanil metilsul, Gallamine triethiodide, Gantacu, Glycine betaine aldehyde, Glycopyrrolate, Methantheline, Methiodide, Methscopolamine, Methylatropine, Methylscopolamine, Metocurine, Natamycin, Oxapium iodide, Oxyphenonium bromide, Palmatine, Pancuronium bromide, Pararosaniline, Pentamine, Penthienate, Pentolinium, Perifosine, Phellodendrine, Pinaverium, Pipecuronium bromide, Prospidium chloride, Pyridostigmine, Pyrvinium, Quatemium-15, Rapacuronium, Rhodamine B, Rocuronium Sanguinarine, Stearalkonium chloride, Suxamethonium chloride, Tetra-n-butylammonium fluoride, Tetrabutylammonium hydroxide, Tetrabutylammonium tribromide, Tetraethylammonium, Tetraethylammonium bromide, Tetramethylammonium chloride, Tetramethylammonium hydroxide, Tetraoctylammonium bromide, Trimethyl ammonium compounds, Trimethylglycine, Trolamine salicylate, Trospium chloride, Vecuronium bromide, and the like.

For example, suitable antibiotics include, but are not limited to amoxicillin, campicillin, piperacillin, carbenicillin indanyl, methacillin cephalosporin cefaclor, streptomycin, tetracycline and the like. Other biocides suitable for use include bactericides, fungicides, algicides, miticides, viruscides, insecticides, acaricides, herbicides rodenticides, animal and insect repellants, and the like.

The following example is intended to be exemplary only, and one skilled in the art will be able to adapt the method in a variety of ways. 300 grams of styrene, 1.6 grams of Vazo 52, and 30 grams of cetylpyridinium chloride are combined to provide a polymerization mixture. Vazo 52 is an azo compound identified as 2,2′-azobis-(2,4-dimethylvaleronitrile) and marketed by E. I. du Pont de Nemours & Company (DuPont) under the trademark Vazo 52. The monomer mixture is heated to about 55-60° C. for 1-2 hours to provide a cured polymer containing cetyl pyridinium chloride.

The dimensions of each of the tubes 12 are only limited by the practical limitations of the photobioreactor system 5. For example, with taller and wider tubes 12, more air is needed to stir the liquid, the tubes 12 take up more space, and it is more difficult and time consuming to perform maintenance on the system 5. Shorter tubes 12 support higher algae densities during growth but require a greater air volume to aerate the culture and are less effective at dissolving carbon dioxide and removing air due to the shorter water path. While tubes 12 can be of any desired length that can be managed during the algae production process, tubes 12 in this particular embodiment are about ten feet in length and can range between about five to fifteen feet in length. Similarly, while tubes 12 have a diameter of any size that can easily be managed during the algae production process, tubes 12 in this particular embodiment typically have diameters ranging from about one to about twelve inches.

As shown in FIGS. 1-2, each tube 12 has a top end 9 connected in fluidic communication with top manifold 16 and a bottom end 11 connected in fluidic communication with bottom manifold 18. Both top and bottom manifolds 16, 18 have a plurality of cylindrical typically raised openings 26 and 27 that extend (typically vertically) from the horizontal axis of each of the top and bottom manifolds 16, 18. In this manner, each respective opening 26 and 27 is positioned substantially perpendicular to the horizontal axis of both the top and bottom manifolds 16, 18. Both the top and bottom manifolds 16, 18 have an equal number of openings 26, 27. Openings 27 of the bottom manifold 18 are positioned so that each opening 27 faces and is aligned along the same vertical plane with a corresponding opening 26 positioned on top manifold 16. Referring to both FIGS. 1 and 2, this orientation allows for each tube 12 to be positioned vertically along the Y-axis of the photobioreactor system 5, when each respective tube's 12 top end 9 is connected to one of the openings 26 of the top manifold 16 and the tube's 12 bottom end 11 is connected to a respective corresponding opening 27 of the bottom manifold 18.

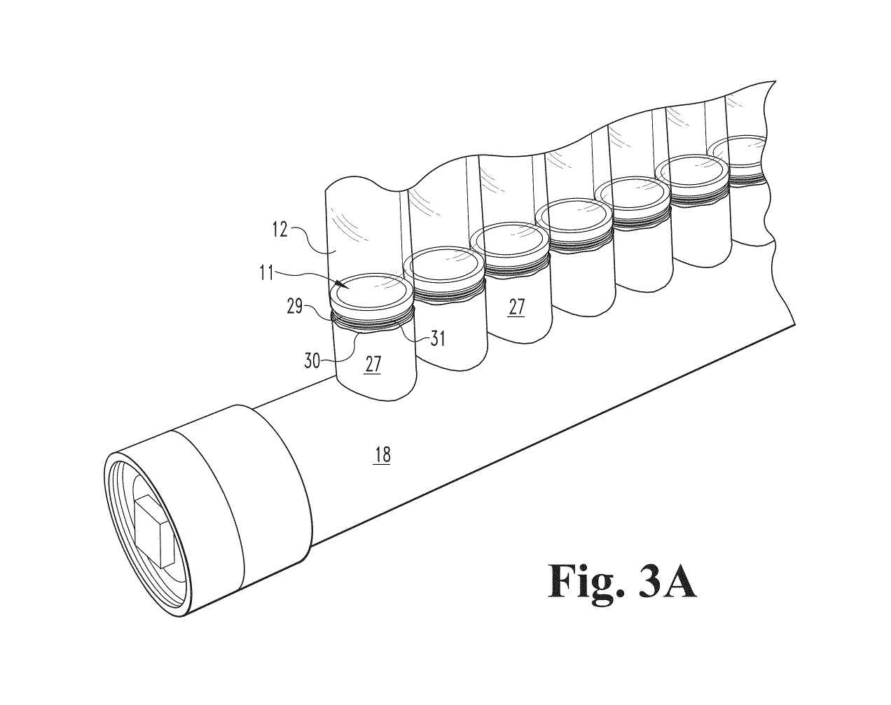

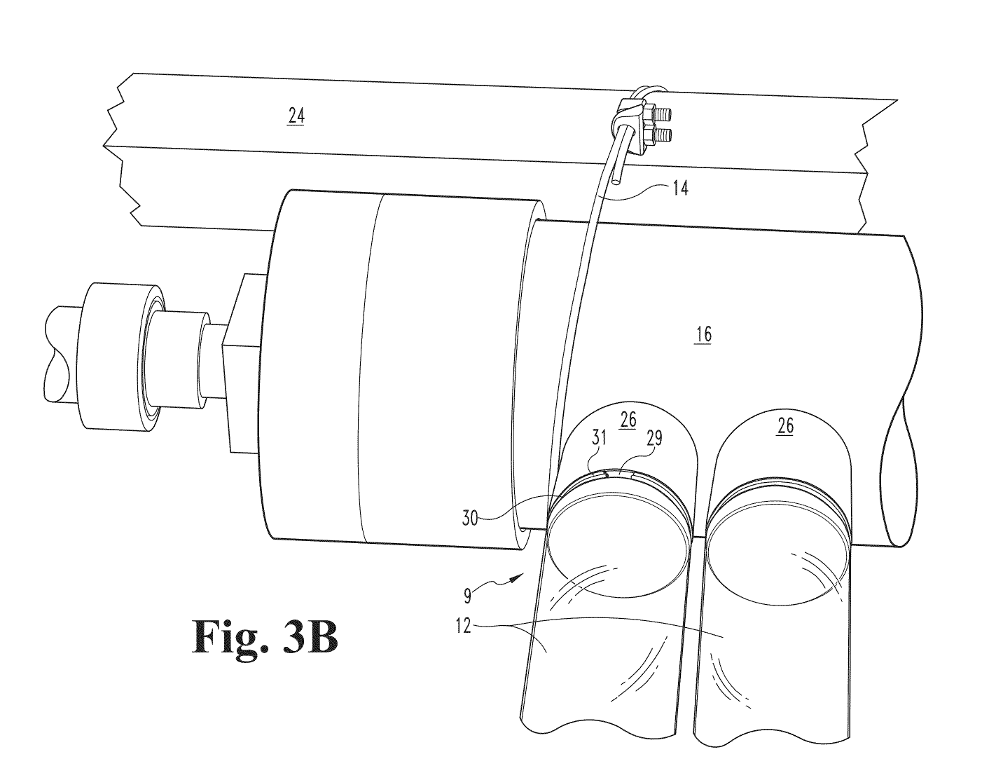

FIG. 3A shows a close up view of the tubes 12 connected to opening 27 of bottom manifold 18. The diameter of tube 12 is typically greater than the diameter of opening 27, so that the bottom end 11 of each tube 12 can slip over and engage a respective raised, cylindrical opening 27. In this manner, opening 27 fits and resides within the bottom end 11 of tube 12. Each opening 27 typically has a groove 29 positioned below the lip of opening 27 and around the outer circumference of the opening 27. A compressible material 30, such as a rubber band or gasket, is placed in the groove 29. After the bottom end 11 is slipped over opening 27, wire rigging 31 is then tightened around the external circumference of both the bottom end 11 of tube 12 and the raised, cylindrical opening 27 at the position of the groove. As the wire rigging 31 is tightened, the gasket material compresses to define a non-leaking seal between the tube 12 and opening 27. In this manner, the tube 12 is held in place around the opening 27 and is connected to bottom manifold 18 to form a pathway that allows fluid and gas to pass in between the tubes 12, openings 27 and bottom manifold 18.

Likewise, as shown in FIG. 3B the top ends 9 of each tube 12 are attached to the raised, cylindrical openings 26 that each correspond in location to the cylindrical opening 27 that the bottom end 11 of each of the tubes 12 is attached to on the bottom manifold 18. Each top end 9 is connected to its respective cylindrical opening 26 in the same manner as each bottom end 11 is connected to cylindrical opening 27 as described above. The diameter of tube 12 is bigger than the diameter of opening 26 so that the top end 9 of tube 12 can slip over the raised, cylindrical opening 26, so that opening 26 fits into and resides within tube 12. Each opening 26 has a groove 29 positioned below the lip of opening 26 and around the outer circumference of the opening 26. A compressible material, such as a rubber band or gasket, is placed in the groove 29. After the top end 9 is slipped over opening 26, wire rigging 31 is then tightened around the external circumference of both the top end 9 of tube 12 and the raised, cylindrical opening 26 at the position of the groove 29. As the wire rigging is tightened, the gasket material compresses to define a non-leaking seal between tube 12 and opening 26. In this manner, the tube 12 is held in place around the opening 26 and is connected to top manifold 16 to form a pathway that allows fluid and gas to pass in between the tubes 12, openings 26 and top manifold 16. Once system 5 is assembled, it is filled with (typically filtered and/or sterilized) water, the desired algae culture(s) is added, a measured amount of nutrients are added, fertilizer is added if desired, and (typically filtered and/or sterilized) air (with our without additional CO₂) is bubbled therethrough. The pH of the water may be controlled by the level of CO₂ in the air stream, chemically, or by any convenient means.

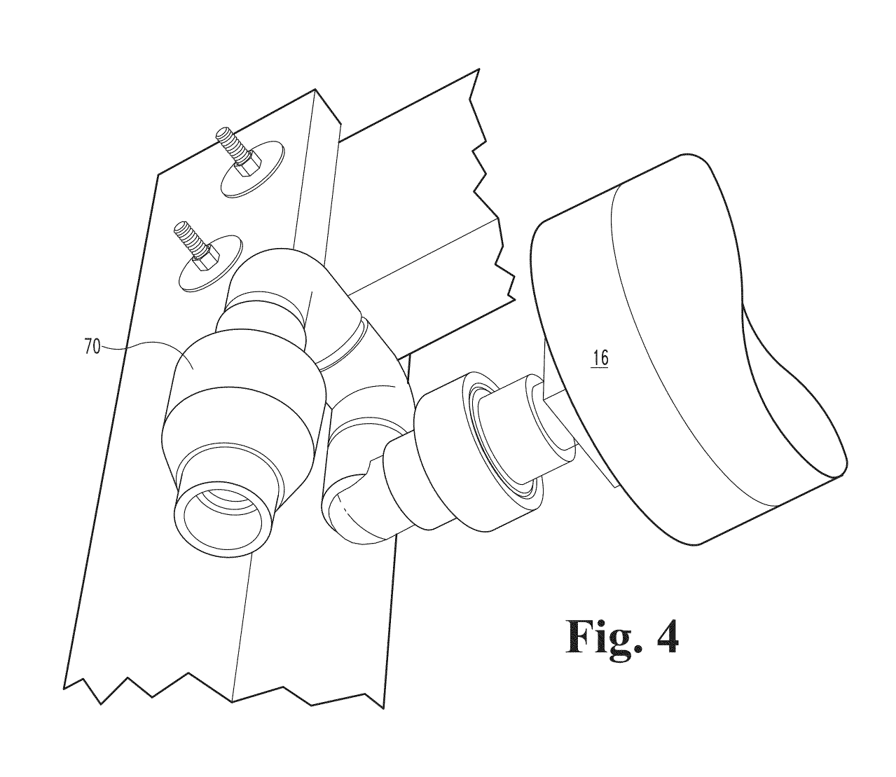

Photobioreactor system 5 is a typically closed, aseptic system operating under positive pressure. As shown in FIG. 4, one or more air exhaust valves 70 are connected in pneumatic communication with upper manifold 16 to allow for excess oxygen to escape the photobioreactor system 5. While it will be appreciated by one skilled in that art that any type of exhaust valve can be used, an exhaust valve 70 that can build up an adequate amount of positive pressure in the system 5 is typically selected. For example, in this embodiment, valve 70 does not open until the gas build up in the system 5 reaches about one-half pound of pressure. In this manner, valve 70 is used to build up positive pressure in the photobioreactor system 5 to prevent contaminants from entering into the system 5. In addition to operating the photobioreactor system 5 under positive pressure, photobioreactor system 5 typically utilizes a plurality of filters and inlet and outlet valves to establish and maintain the aseptic environment.

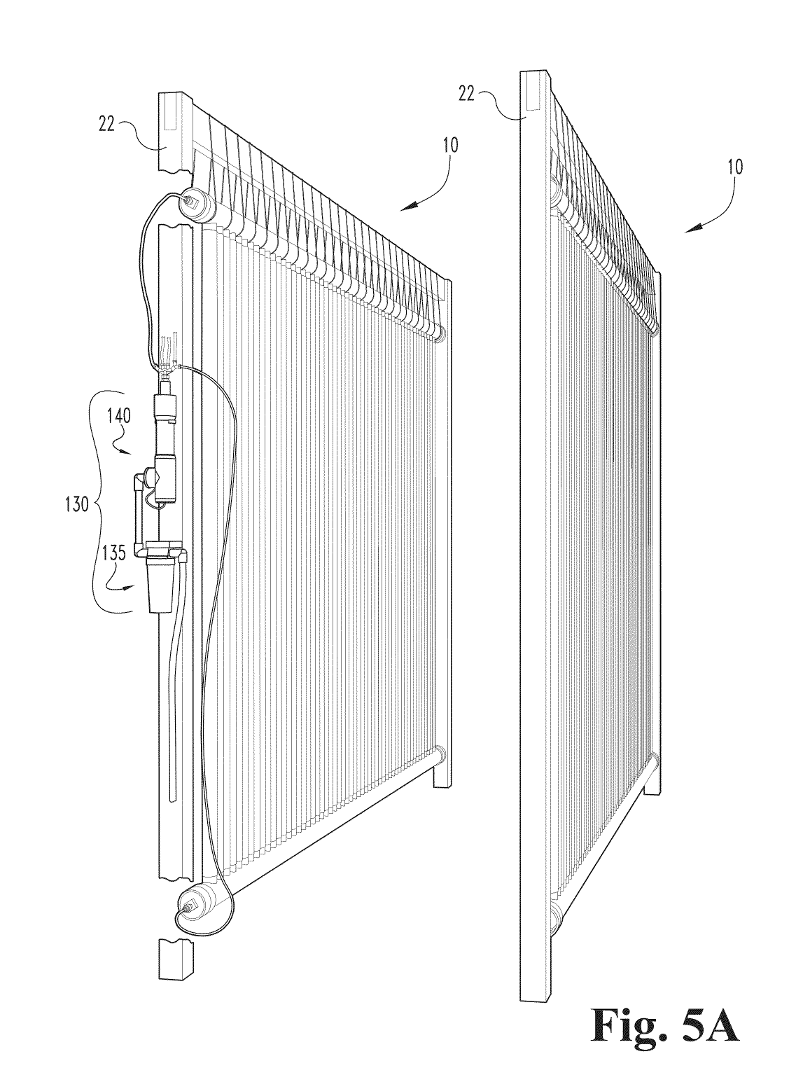

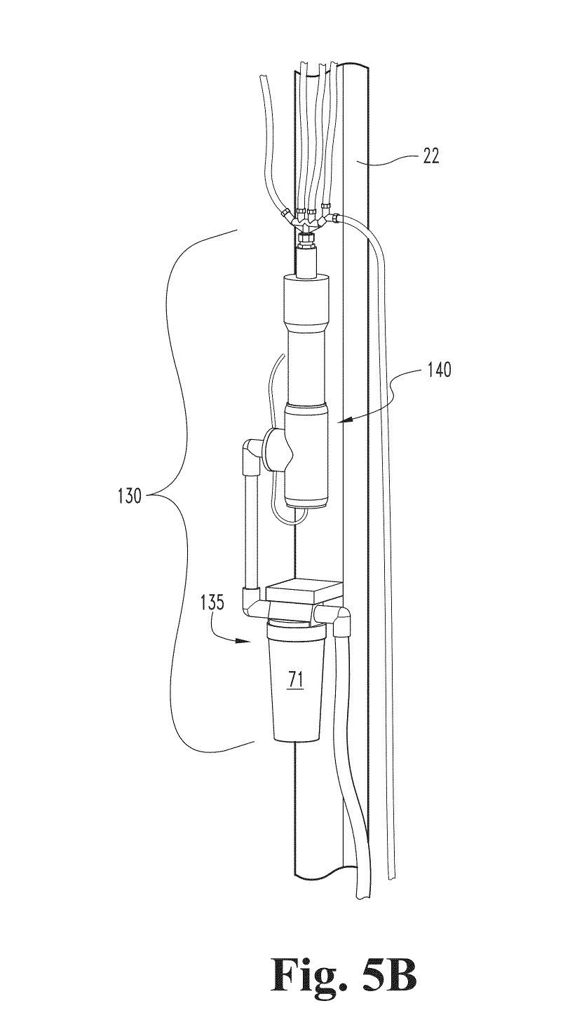

FIGS. 5A and 5B illustrate two photobioreactor arrays 10 in wherein arrays 10 are filled with an algae culture and with liquid media made up of sterile water and fertilizer respectively. The media water can be provided by any water source 120 or can be recycled from previous cultures. Prior to being added to photobioreactor array 10, the water is passed through a filter and UV sterilization bank to remove particles and neutralize contaminants. As shown in FIG. 5B, water filtration system 130 comprises a micro-filter 135 and a UV sterilization bank 140. Filtration system 130 is used to filter water to remove biological contaminating particles (e.g., bacteria, mold, fungus, and other micro-algae species) and the water is irradiated with UV-B or UV-C light in the UV sterilization bank 140 to ensure the media water is sterile. It will be appreciated that any suitable water treatment filters 135 can be used and that the UV sterilization bank 140 can be set to known irradiation levels to eliminate the biological contaminants of concern.

The fertilizer used in the photobioreactor system 5 will largely depend on the nutrient requirements of the particular species of algae being cultivated. The fertilizer is typically added to the filtered media water and then fed into the photobioreactor system 5 at the same time as the media water. The media water and fertilizer are typically added through a water tube and an inlet valve. If the media water is recycled from a previous culture, the media water may have some fertilizer still present. In such cases, the fertilizer concentrations in the media water are measured and additional fertilizer is added, only as needed, to add the desired nutrients to the media prior to re-introduction into a photobioreactor array 10.

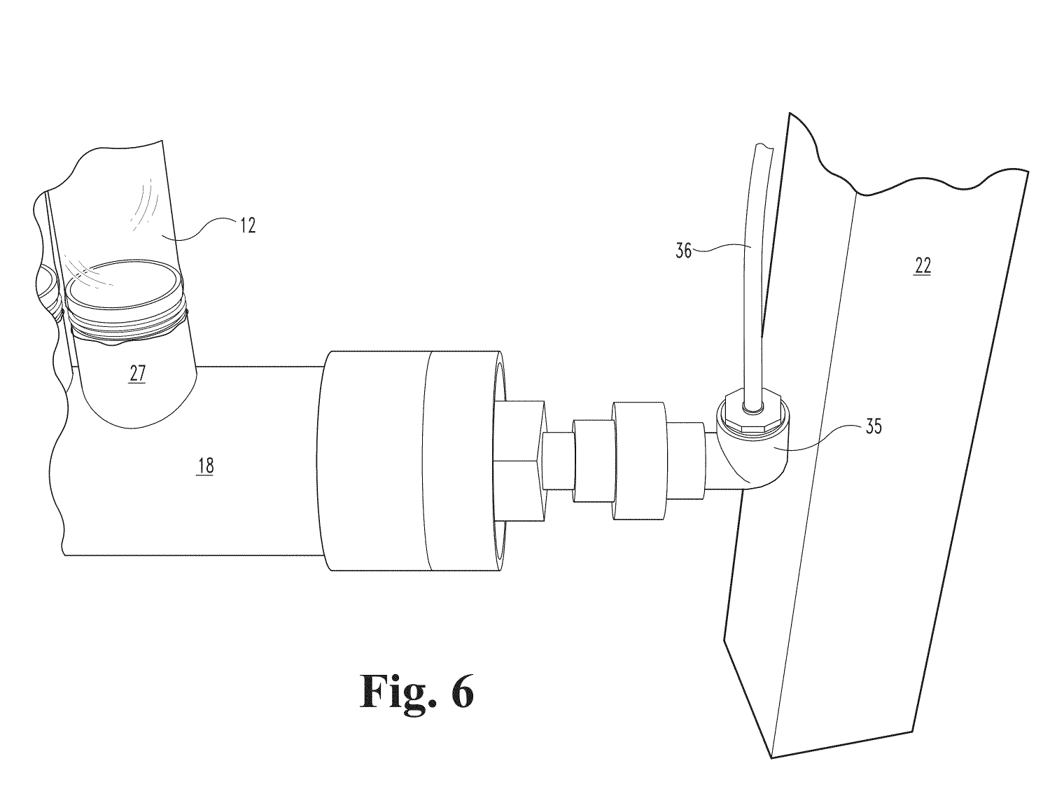

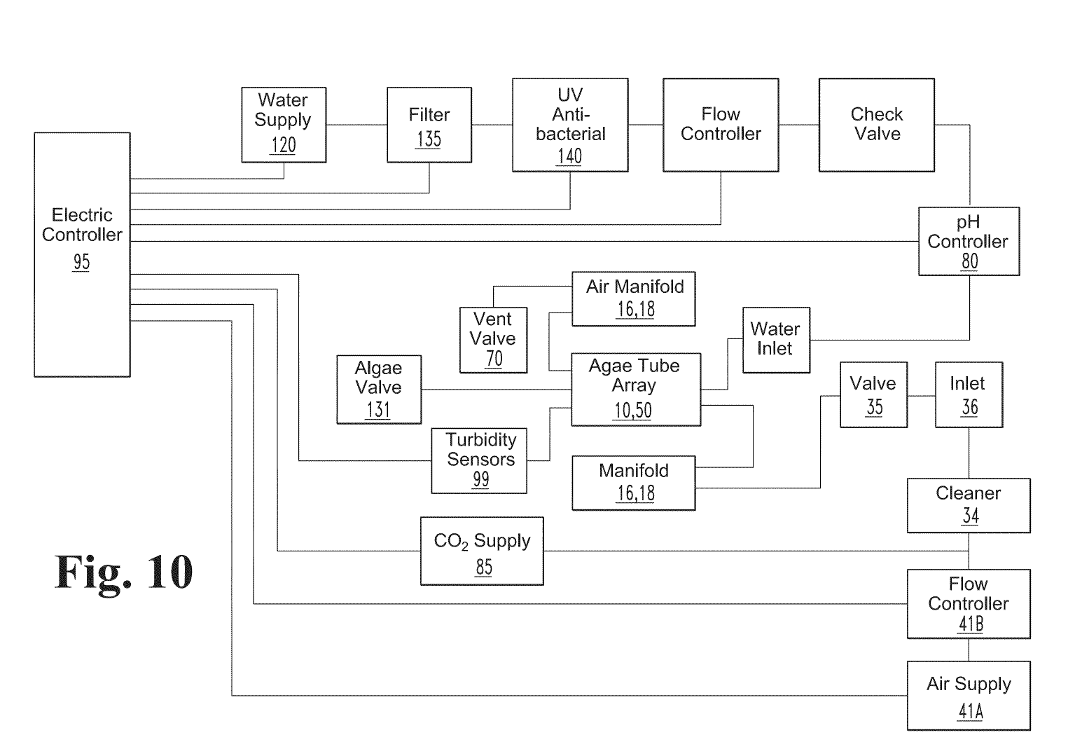

Aeration of the photobioreactor system 5 is performed to facilitate gas exchange for removal of excess oxygen and deliver carbon dioxide to promote the growth of the algae. Air, with or without additional carbon dioxide, is added to the photobioreactor system 5 to control the pH of the culture and to promote algae growth. FIG. 6 shows a close up view of the gas inlet port 35. Prior to entering into the bottom manifold 18, air (with or without additional carbon dioxide) flowing through a gas inlet tube 36 passes through a microbe filter 34 (See FIG. 10) to remove any potential contaminants prior to being introduced into the photobioreactor system 5. Gas inlet tube 36 feeds air (with or without additional carbon dioxide) to the lower manifold through gas inlet valve 35 to aerate the culture. To avoid contamination, the gases introduced into the photobioreactor system 5 are typically sterilized and/or or passed through a filter, such as a HEPA filter of 0.2 micron size or less.

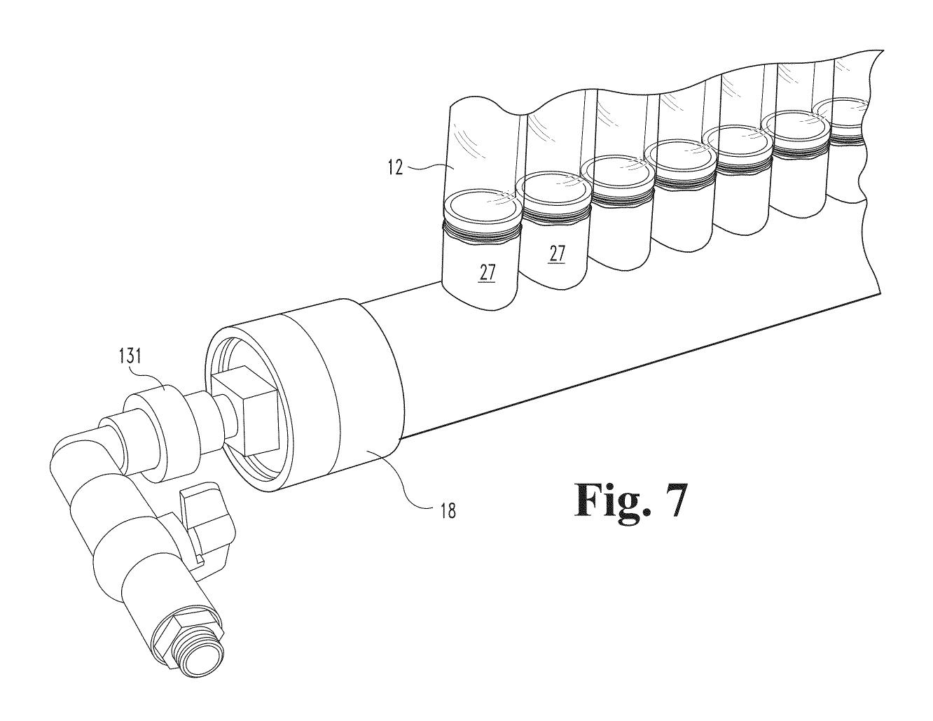

FIG. 7 shows a close up view of the outlet valve 131 used to harvest algae from photobioreactor system 5. To harvest the algae being cultivated, valve 131 may be opened to allow for the culture to drain from the photobioreactor system 5, such as through a hose. Typically, harvesting involves removing about one-third to about one-half of the culture in the system 5. Alternately, harvesting may be performed as a continuous or quasi-continuous process, such as by frequently extracting small quantities (such as on the order of a gallon or so), which has the advantage of keeping the algae density high. After exiting photobioreactor system 5, the algae can be removed from the media water through any number of ways known in the art. As discussed above, the media water may be recycled and used to refill the photobioreactor system 5.

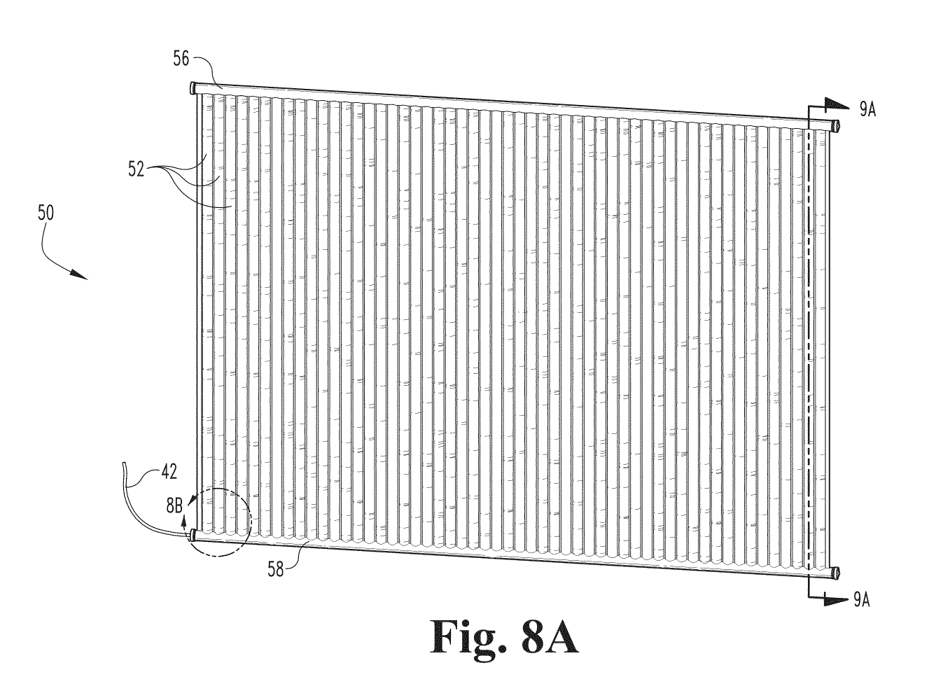

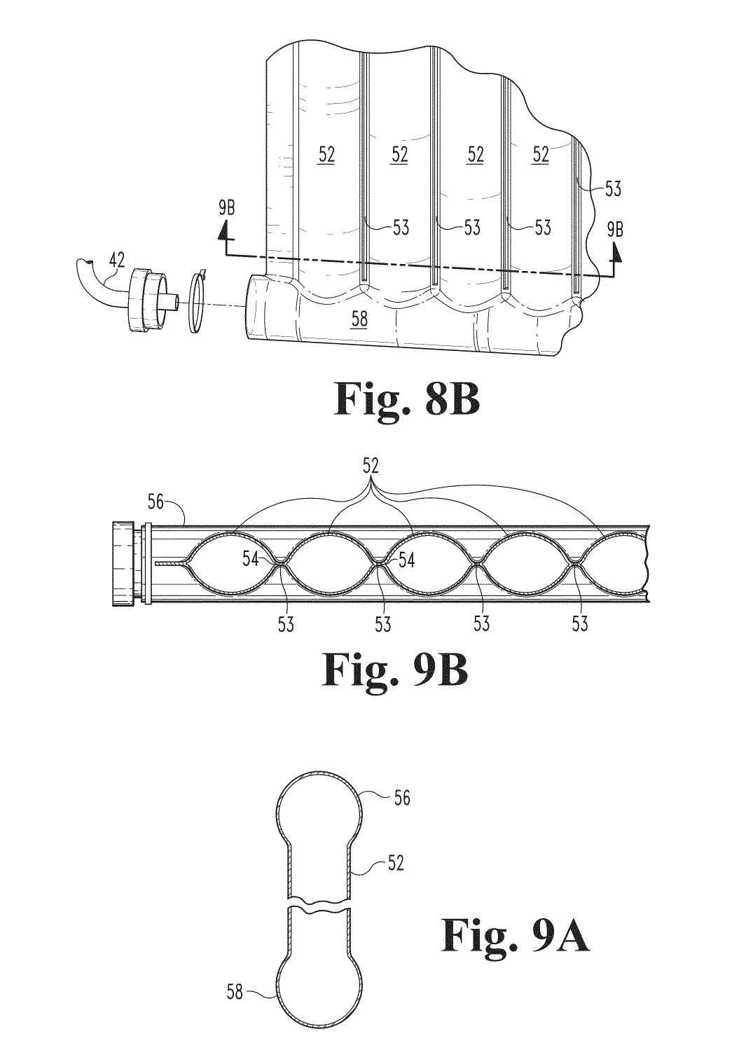

As shown in FIGS. 8A-9B, another embodiment of the photobioreactor system 50 replaces the array of tubes and the rigid top manifold and rigid bottom manifold with a single-piece bag construction made from a thin, inexpensive film. Similar to the films used to create the tubes 12, the film used to construct the single-piece bag photobioreactor 50 typically exhibits a tensile strength sufficient to hold the liquid media under the system's 50 operating temperatures, some degree of UV radiation resistance, durability when being handled, visible light transparency; and stretching characteristics that prevent the formation of a tear-drop shape or the tubes 12 from pillowing-out when the tubes 12 are filled. In the single-piece bag photobioreactor 50, the film is typically selected to maintain the desired structural dimensions of the system 50 when filled. Suitable films that can be used include, but are not limited to, the previously described LDPE, ETFE, or PET films.

The single-piece bag photobioreactor system 50 comprises a plurality of vertical tubes 52 of the same general construction as the tubes 12 of the previous embodiment. While tubes 52 are all part of the single-piece or unitary bag photobioreactor 50, tubes 52 are typically separated from one another by plastic seals or welds 54 that form the vertical walls of tubes 52 and define open spaces 53. The single-piece bag photobioreactor 50 replaces the rigid manifolds of photobioreactor system 5 and incorporates a top manifold portion 56 and bottom manifold portion 58 into the single-bag construction, so that each of the top and bottom manifolds 56, 58 are defined by horizontal tubes 52 formed in the film. In producing the single-piece bag design for photobioreactor 50, the tops of tubes 52 are integral with and open to top manifold 56 and the bottom of tubes 52 are integral with, and open to, top manifold 56 to form fluid and gas pathways, so that fluid and gas can pass through each of the tubes 52 and into and out of respective top and bottom manifolds 56, 58.

While this embodiment has multiple tubes 52 separated by welds 54 and open spaces 53, it will be appreciated that various structures and methods of manufacturing the photobioreactor system 50 can be used. For example, photobioreactor system 50 can be constructed from a single sheet of plastic, where the sheet of plastic is folded in half and a set number of welds 54 and wishbone cuts 53 are made to define the tubes 52 and manifolds 56, 58. Alternatively, the sheet of film can be pressed into a mold to form the tubes 52 and manifolds 56, 58 or each of the components (e.g., the tubes 52 and manifolds 56, 58) can individually be blow molded or the like and then assembled together to form the photobioreactor system 50. No matter the method of construction used, the photobioreactor system 50 is also typically equipped with enough rigid ports to support at least one exhaust valve, gas inlet valve, water inlet valve, and water outlet valve. These valves are used in the same manner as discussed in association with photobioreactor system 5, so that the photobioreactor system 50 is a substantially closed, aseptic system, typically operated under positive pressure to prevent or minimize the introduction of contaminants in the system.

As discussed in association with tubes 12 for photobioreactor system 5, tubes 52 can be of any desired length that can be managed during the algae production process. While tubes 52 can be of any desired length, tubes 52 in this embodiment are typically about 10 feet long and typically range between about 5 to about 15 feet in length. Similarly, while tubes 52 may have diameters of any convenient size that can easily be managed during the algae production process, tubes 52 in this embodiment typically have diameters ranging from about 1 to about 2 inches. In addition, while the width of the single-piece bag photobioreactor system 50 can be any convenient width, it is typical that the width of the system 50 is between about 10 and about 100 feet.

Single-piece bag photobioreactor system 50 typically has a plastic margin that includes a plurality of vertical cutouts or slots. The plastic margin 60 is typically sufficient size and structural strength to support the weight of the entire photobioreactor system 50 when filled with fluid. The single-piece bag photobioreactor system 50 may be connected to the top rail 24 of a frame 21 by any number of mechanisms known in the art, including, but not limited to, threading wire riggings 14 through slots to hang the system 50 from top rail 24 or fixing a plurality of hooks on top rail 24 and threading the hooks through slots to hang the system 50 from the top rail 24.

FIGS. 9A and 9B show cross-sectional views of the single-piece bag photobioreactor system 50 along sections A-A and B-B of FIGS. 8A and 8B, respectively. Section B-B provides a view of the bottom/lower manifold 58 and diagrams the flow of liquid and gas from the bottom manifold 58 through tubes 52. An aeration tube 42 is positioned within lower manifold 58. While the lower manifold 58 can have any size diameter, the lower manifold 58 of this embodiment has a diameter of about 3 to 4 inches. Aeration tube 42 allows for bubbles to form along the length of the tube 52. It is important that the aeration tube 42 is selected so that the bubbles provided to the culture in tubes 52 do not give rise to shear damage to the algae, and also provide enough surface area for effective gas exchange. For example, if the bubbles are too small (i.e., smaller than the cells of the algae culture) the bubbles will enter the culture at a high velocity and may cause shear damage to the algae. Further, if the bubbles are too large, there will not be enough surface area for effective gas exchange. It has been found that a paper diffuser, such as those made commercially available by AquaticEco Systems, can serve as an effective aeration tube 42 and be used to provide bubbles with the desired size.

The air bubbles from an air supply 41A leave the aeration tube 42, entering into the culture, and traveling up through tubes 52. Flow rate is typically determined by a flow controller 41B connected in line between the air supply and the air cleaner 34. As the bubbles leave the aeration tube 42 and travel through the tubes 52, the air urges the culture to stir and creates turbulence in the respective tubes 52. As a result, tubes 52 self-organize into a set of up-flows and down-flows with the mixing occurring between them in the top and bottom manifolds 56, 58. The constant mixing keeps nutrients evenly dispersed, keeps gas well dissolved, and keeps algae from precipitating or sticking to the surfaces of tubes 52 or the manifolds 56 and 58. Thus, unlike other prior art systems that use additional components, such as pumps, to mix the culture and create turbulence, photobioreactor system 50 does not require anything else than the pressurized air to be delivered through the aeration tube 42 to promote mixing of the culture and create turbulence.

The pressure of the air being provided only needs to exceed the pressure of tube 52 that is filled with culture (e.g., for a 10 feet tube—4 to 5 psi), plus the head resistance of the aeration tube 42, (e.g., for a paper diffuser about 0.5 psi) and the excess pressure for the inlet air valve (e.g., about 0.5 psi), and finally, any head loss in the air delivery tubing and filter used to deliver the air to the culture. Thus, air delivery systems that are able to deliver air in the range of at least about 6 psi to 8 psi would be sufficient for use in this embodiment. Such air delivery systems can include, but are not limited to, a roots blower system, an array of fan blowers, or an air compressor. The air delivery system can be connected to the lower manifold 58 by gas inlet tube 36 (See FIG. 6).

Air delivery systems typically deliver the gas at a constant air flow rate that will largely be dependent on the diameter of a tube 12, 52. For example, a one third reduction in tube diameter yields a one-half reduction in the air volume requirements. A single tube 12, 52 that has a diameter of 45 millimeters should have a flow rate of about 4 to 5 liters per hour. Accordingly, the air flow rate for the photobioreactor system 5, 50 can be calculated by multiplying the number of tubes 12, 52 that are part of the system 5, 50 by the requisite flow rate. If the system 5, 50 contains fifty tubes 12, 52, each with a diameter of 45 millimeters, the air flow rate of the system 5, 50 should be in the range of about 200 to 250 liters per hour. It will be appreciated that the desired air flow rate can be calculated in a similar manner for larger or smaller applications.

Photobioreactor system 5, 50 is typically equipped with a pH probe to monitor the pH levels of the culture. Evolved oxygen from photosynthesis under lighted conditions contributes to alkalinity of the culture. To maintain approximately neutral pH for promotion of algae growth, the excess evolved oxygen is typically substantially continuously removed. In addition, the pH can be controlled by introducing additional carbon dioxide from CO₂ source 85 to lower the pH. The pH probe is in electronic communication with a controller 80 that is operationally connected to at least one solenoid. The controller 80 and solenoid govern when additional carbon dioxide is added to the air being fed to the photobioreactor system 5, 50.

Flue gas from a carbon dioxide producer (e.g., a coal fired plant) could serve as the carbon dioxide source 85 and be fed at the desired pressures (i.e., 6 psi to 8 psi) to the photobioreactor system 50 through gas inlet tube 36 and aeration tube 42. Alternately, any convenient CO₂ source may be used to achieve a high CO₂ partial pressure gas mixture for bubbling through the bioreactor system 50. When using a flue gas stream, it would likely be necessary to strip some of the carbon dioxide from the stream and/or to provide a nitrogen stream for aeration of the culture. Alternately, the flue gas stream may be diluted with air or nitrogen. Due to the high concentrations of carbon dioxide in flue gas, too much carbon dioxide could be absorbed in the culture, which could lead to increased acidity. If left uncontrolled, the low pH could inhibit algae growth or even kill micro-algae. It will be appreciated by one of ordinary skill in the art that there are a number of ways that some of the carbon dioxide can be removed from the flue gas stream. For example, one way to usefully decrease the concentration of the carbon dioxide would be by running the flue gas through an aqueous ammonia solution before supplying it to the photobioreactor 5, 50.

In addition to adding carbon dioxide to the culture, aeration assists in the removal of the excess evolved oxygen produced from photosynthesis. Typically, the top/upper manifold 16, 56 is of sufficient size to not be completely filled with fluid when the photobioreactor system 5, 50 is in use. In this manner, an air space is generated in top manifold 56. While the top manifold 56 may have any convenient diameter size, the top manifold 56 used in this embodiment has a diameter typically ranging from about 4 to about 6 inches.

The air bubbles flow up from aeration tube 42, pass through the media in tubes 52, and then exit the media in the upper manifold 16, 56 into the airspace. As the air flows in this manner, carbon dioxide is introduced into the system 50 and absorbed by the algae during photosynthesis, and oxygen is generated and released to air space 40. One or more (typically one-way), exhaust check valves 70 are placed on the end of the upper manifold 16, 56 to allow the excess oxygen to escape the photobioreactor system 50 when the pressure exceeds 0.5 PSI. By venting the oxygen in this manner, the pH levels may be controlled and the growth of algae may be optimized.

While the forgoing discussion refers to the flow of fluid, algae and gas through the single-piece bag photobioreactor 50, it will be appreciated that photobioreactor system 5 allows for the flow of fluid, algae and gas in between its vertical tubes 12 and top and bottom manifolds 16 and 18 in the same manner that the fluid, algae and gas flow through photobioreactor system 50. It will also be appreciated that the bottom manifold 18 of photobioreactor system 5 also has an aeration tube 42 and the top manifold 16 also has an air space 40 as described above. In this manner, the culture is continuously mixed at the top and bottom manifolds 16, 18 and throughout the tubes 12. The substantially constant mixing keeps nutrients evenly dispersed, keeps gas well dissolved, and keeps algae from precipitating or sticking to the surfaces of tubes 12 or the manifolds 16, 18.

The maximum density obtainable in the algae culture in a photobioreactor system 5, 50 is generally related to the availability of light and nutrients and the micro-algae species under cultivation. Nutrients are taken up by organisms at varying rates. As known to those skilled in the art, nutrient starvation, high or low temperatures, and under or over-concentration of biomass left uncontrolled can inhibit the growth of or even kill micro-algae. To prevent under or over-concentration of biomass in the photobioreactor system 5, 50, the concentration of micro-algae may be measured such as by using turbidity. To reduce the concentration of biomass in the culture, a portion of the biomass is harvested and the culture is diluted with fresh media. The ideal dilution rates correspond to the cellular generation time or growth rates. Typically, harvest and dilution is carried out during the light period and is halted during the night when little additional biomass is being produced. Any means known in the art can be used to measure the turbidity of the culture. For example, turbidity sensors 99 can be added to the photobioreactor system 5, 50 to continually monitor the turbidity levels. Such sensors can be in electronic communication with a controller that controls one or more solenoids. The controller and solenoids can be used to govern the media inlet valves and harvesting outlet valves. When the turbidity reaches a predetermined set point, the controller and solenoid can be used to open the media inlet valve and harvesting outlet valve, so that fresh media can be added to the photobioreactor system 5, 50 and a portion of the culture can be harvested to dilute the culture to the desired turbidity.

In addition to controlling pH levels and the concentration of biomass, the temperature of the photobioreactor system 5, 50 needs to be maintained as well. The particular algae strain being cultivated will dictate the range of temperatures that will need to be optimally maintained for the culture. Any number of technologies can be used to make sure the culture is grown in the desired temperatures. For example, the heat of the surrounding environment can be controlled through any number of known methods or a heat exchanger can be positioned within the bottom manifold 18, 58 to allow for the culture to be heated or cooled.

To produce algae on a large scale, several photobioreactors 5, 50 can be set up on a farm to optimize the light available to algae and thereby maximize culture density. Algae grows best in low light levels, so it is preferred to configure the farm to position the photobioreactors 5, 50 in a pattern that will keep the light levels that will optimize the growth of the species of algae being grown. Those skilled in the art will appreciate that the available light must still be within the photosynthetically active radiation portion of the spectrum, somewhere within the range of 400 nm to 700 nm. For example, if Botryoccus brauni (Bb) is the species of algae being cultivated, the photobioreactors can be positioned in a pattern that will keep the light levels down to 1/10^{th} or 1/20^{th} of full sunlight and/or to maintain the light intensities below 250 W/m² over significant proportions of the bioreactor surface. For this species, it is preferred that the photobioreactors 5, 50 are positioned to maintain light intensities in the range of 60 to 120 W/m². Other species of algae have different preferred light intensity ranges. As a non-limiting example, selenastrum minutum prefers light intensity ranges of 150-450 μE/m̂2/s, Coelastrum microporum f. astroidea prefers light intensity ranges of 150-450 μE/m̂2/s, Cosmarium subprotumidum prefers light intensity ranges of 150-400 μE/m̂2/s, Chlorella pyrenoidosa prefers light intensity ranges of 100-600 μE/m̂2/s Chlorella vulgaris prefers light intensity ranges of 60-120 μE/m̂2/s Scenedesmus obliquus prefers light intensity ranges of 80-400 μE/m̂2/s Chlamydomonas reinhardti prefers light intensity ranges of 100-600 μE/m̂2/s, Haematococcus pluvialis growth phase prefers light intensity ranges of 80-260 μE/m̂2/s, Haematococcus pluvialis during the non-growth phase prefers light intensity ranges of 250-260 μE/m̂2/s, Phaeodactylum tricornum prefers light intensity ranges of 100-300 μE/m̂2/s, and Alexandrium catenella prefers light intensity ranges of 100-300 μE/m̂2/s. As can be determined from the preferred light ranges, Haematococcus pluvialis can require two distinct photobioractors due to the differences in preferred light ranges during its growth and non-growth phase. Note that the lower portion of the preferred light ranges can be used and can result in higher quantum efficiency; the micro-organism makes a higher percentage use of the available photons.

At its maximum intensity on the ground, sunlight has a light intensity between about 1,000 W/m² to about 2,000 W/m². Thus, to reduce the maximum light intensity to about 100 W/m² requires an increase in surface area of about a factor of ten. Based on 1 inch diameter bioreactor tubes 12, 52, a square meter of vertically hanging array of tubes 12, 52 would hold approximately 12.7 liters of fluid. Thus, spreading the light through ten square meters would provide a specification of 127 liters of culture per square meter or 513,951 liters per acre. By using 10 foot high, 2 inch in diameter bioreactor tubes 12, 52, the photobioreactor systems 5, 50 can have an array 10, 50 of about fifty bioreactor tubes 12, 52 per square meter. Keeping in mind these specifications, the vertically hanging tubes 12, 52 can then be equally spaced horizontally over a distance of about thirty feet to achieve the desired light intensities. It will be appreciated by those of ordinary skill in the art that as the length of the tubes 12, 52 increase, the spacing between the tubes 12, 52 should also increase and likewise, as the length of the tubes 12, 52 is decreased, the spacing between the tubes 12, 52 should decrease to achieve the desired light intensities.

To assist in maintaining the desired light intensities, the horizontal X-axis of the photobioreactors 5, 50 should be oriented along the north-south direction, if sunlight is a contributing light source. This orientation helps keeps the light made available to the photobioreactor system 5, 50, indirect, diffuse, and evenly spread the over more of the photobioreactor 5, 50 area. Moreover, when using multiple photobioreactors 5, 50, the photobioreactors 5, 50 should be positioned relative to each other to assist in optimizing the light for each photobioreactor system 5, 50. For example, it is preferred that photobioreactor systems 5, 50 having 10 foot high, 2 inch in diameter bioreactor tubes 12, 52 be positioned in parallel rows (See FIG. 3A) with a distance of about two feet in between the rows. To further optimize the light, the surrounding structural members and the ground can be covered with reflective materials to prevent absorption of useful light by the structural members and the ground. For example flat white paint can be used to cover regular concrete or even white concrete can be used to prevent absorption of useful light by the ground (floor).

As a more detailed explanation, a set of photobioreactors can be positioned in order to obtain indirect or diffuse illumination with a low level light intensity. In some implementations, this means a collection or set of photobioreactors can be positioned with a substantially north-south linear orientation (the longitudinal axis is aligned in a north-south orientation). That is, the longitudinal axis of the photobioreactor is oriented such that the longitudinal axis is substantially parallel to a line extending from 0° to 180° (north-south). The distance between photobioreactors is such that the ratio of the surface area of the photobioreactors to the surface area of the earth under them is 10:1 or 20:1. Thus, a 10 foot tall by 10 foot long photobioreactors would have two faces with 100 square feet each (for a 200 square foot surface area). Note that because the tubes of the array are parallel and close to each other, the surface area of the photobioreactor can be modeled as the photo-active footprint of the photobioreactor. That is, the surface area of a photobioreactor as described within this application for the purpose of this calculation can be considered to be the area of a plane of equal dimensions to the photobioreactor. Or in other words, two times (for both sides) the area of a rectangle of length and height equal to a photobioreactor. If photobioreactors were spaced at a distance of 2 feet (on center) then (10 foot×2 foot=) 20 square feet would be the surface area of the earth under them. The ratio of surface areas would then be 200:20 or 10:1. As long as the light is mostly indirect and diffuse and reflects from the ground—then this will approximate the light expected light intensity across the surface of the photobioreactors in the field or set. This is because of the orientation (north-south not facing the sun) and self-shading of photobioreactors by neighboring photobioreactors. Note, those photobioreactors on the outer portions of the collection of photobioreactors can be partially shaded through various means such as fabric mesh, screens, and the like to ensure all photobioreactors experience the reduction in available light. The optimization of distances between the photobioreactors can be characterized as Total Area allocated to

Photobioreactor=Area of Photobioreactor/(Actual Light Intensity/Preferred Light Intensity) where, for

the purposes of this calculation, the lower end of the preferred light range can be used.

The following is an example demonstrating the placement of a collection of photobioreactors to incubate haematococcus pluvialis during its growth phase. Full sunlight in central Indiana has the approximate power of 2000 μE/m̂2/s. That is, the average light intensity striking the greenhouse is full sunlight. However, an average of the available light intensity can be used for those situations where the light intensity will vary substantially through the day. Full sunlight suffers approximately a 20% reduction when passing through the roof of a greenhouse, leaving the transmitted sunlight to be 1600 μE/m̂2/s. In this example, it is expected that sunlight will remain at or near full strength throughout the majority of the day. Haematococcus pluvialis during its growth phase prefers light intensity ranges of 80-260 μE/m̂2/s. Using 80 μE/m̂2/s as the targeted value yields a ratio of 1600:80 or 20:1. If the photobioreactors are 10′ tall by 10′ long, the sides of each photobioreactor have a total area of 200 square feet. 1/20^{th} of 200=10 sqare feet. Thus, the photobioreactors should be spaced about 1′ apart. In more formal notation, the placement area occupied by pbr=surface area of pbr/(available light/preferred light). That is, the total area available in which the photobioreactors are to be placed can be thought of as having a grid superimposed upon it, with a photobioreactor occupying the center of each cell of the grid. The size of each cell of the grid is equal to the area of pbr/(available light/preferred light).

Similarly, the tube diameter of the vertical tubes of a photobioreactor can also be optimized according to the expected max culture density of the micro-organism being cultured. For example, scenedesmus dimorphus can achieve a culture density of 1.75 gm/l. Under such a density, measured values indicate that scenedesmus dimorphus causes light intensity within the tubes to decrease by halve every 0.25 inches. Other species of algae will exhibit different absorption of light and can be measured for their respective light intensity half length. The light intensity penetrating the culture of scenedesmus dimorphus is insufficient to promote growth of the algae after four decreases (four halvings) of the light intensity. That is, after four halvings of the light intensity, any light available ceases to be photosynthesis viable for scenedesmus dimorphus. Note that the volume of culture per foot of tubing increases as the square of the radius of the tubing. However, the lighted culture volume per foot of tubing (that portion of the culture exposed to light within the tubing) is equal to the difference between the total volume per foot of tubing minus the volume of foot of tubing not receiving light. That is, lighted volume per foot of tubing=πr²−π(r−4*light intensity half length)². This value increases linearly as the radius of the tubing. Thus, a tube diameter can be chosen as to maximize the amount of culture that is being exposed to light while maximizing the total volume of culture. That is, that the ratio of the lighted culture volume per foot to the total culture volume per foot of tubing can be maximized. The ratio of lighted culture volume to total volume per foot is πr²−π(r−4*light intensity half length)²/(πradius)² simplified as 16(light intensity half length)²−8(light intensity half length)radius/radius². For scenedesmus dimorphus at a density of 1.75 g/L, this quantity achieves a maximum value at approximately 0.68 inches. Thus, a film tubing with a diameter of 1.36 inches represents a tube diameter that maximizes the amount of culture that is being exposed to light while maximizing the total volume of culture. However, some implementations utilize off-the-shelf available tubing. One such type of film tubing utilized for some implementations is law-flat tubing. Because lay-flat tubing is available only in inch diameter increments, beginning with two inches, the two inch diameter lay-flat tubing is chosen as it is the diameter of tubing available that maximizes the amount of culture that is being exposed to light while maximizing the total volume of culture.

For example, knowing what light intensities are optimal for the desired species of micro-algae within a culture allows the optimization of production of a culture for the desired photoautotroph or mixotroph micro-algae species. For example purposes, assume that a culture of Botryococcus braunii is desired. Botryococcus braunii prefers a light intensity of 60 to 120 micro-moles of PAR photons per meter̂2 per second. However, it remains that productivity is upper bounded by the amount of light available subject to the limitations caused by photinhibition and photooxidation. Photinhibition is the light-induced reduction in the photosynthetic capacity of a plant, alga, or cyanobacterium. Photooxidation is when the rate of energy capture and resulting energy directed to carbon-fixation being too high in comparison with the rate of diffusion of CO2 into the cells. As a result, oxygen replaces carbon dioxide and is not allowed to diffuse out; in effect crowding out CO2 when it does appear. This reduces the rate of carbon fixation at higher light intensities while still using up the energy captured from incident photons. Thus, in simplified terms, the optimization of the bioreactor includes 1) decreasing the light intensity to a light intensity in a range preferred by the desired micro-algae and 2) increasing the available CO2. The second can be readily accomplished through the addition of CO2 or through the addition of carbonate into the medium. The first is accomplished through 1) decreasing inter-PBR spacing and/or decreasing the inter-tube spacing; and 2) increasing PBR pipe or tube diameter. As the pipe diameter gets smaller, consequently increasing the volume of medium as compared to the available light, the spacing of multiple photobioreactors can become more dense in an effort utilize the collective reduce the average light levels per photobioreactor. However, as the pipe diameter gets smaller, the density of the culture, under desirable light levels, increases (assuming the spacing or light level remains the same) due to less in-culture light reduction. It also should be noted that as a practical concern, more and more material (plastic film, etc.) is needed to hold the same amount of culture volume as you reduce pipe diameter and decrease the spacing distance (i.e., as pipe diameter decreases more pipe length is required to contain the same volume of culture). Other practical concerns include spacing of the photobioractors to enable proper monitoring and maintenance.

In some locations of desired implementations, the intensity of incident sunlight is about 1500 to 2000 micro-moles of PAR photons per meter̂2 per second. However, the intensity of incident sunlight is reduced by passing through and into a greenhouse structure. Exemplary values for the intensity of the remaining incident sunlight range from 1200 to 1500 micro-moles of PAR photons per meter̂2 per second within the greenhouse. It should be understood that the intensity of the remaining incident sunlight can be measured for a particular structural instance. Thus, the reduction of 1200 μE/m̂2/ŝ2 to 60 to 120 μE/m̂2/ŝ2 is a ratio of surface area of about 10 to 20 to 1. However, the reduction of 1200 μE/m̂2/ŝ2 to 60 to 120 μE/m̂2/ŝ2, a ratio of surface area of about 10 to 20 to 1, is only one of the considerations for optimization. The optimization of the dimensions of the photobioreactor 5 must also account for effective combinations of culture density and culture volume while providing for efficient stirring and air exchange to support respiration. The parameters of tube diameter, tube height, and tube separation distance—should be set to maximize productivity while minimize both capital and operational costs while providing sufficient space for maintenance access to the system. That is to say, the tube diameter, tube height, and tube separation distance are selected to maximize the amount of biomass produced per unit surface area of the ground per time.

Similarly, parameters such as tube or film thickness much be considered in this optimization. For example, while plastic films with thicker, and hence more expensive films, enabling longer and larger tubes, the associated capital costs can also increase, contributing to the costs of the raw materials. The example is continued while holding a ratio of surface area of about 10 to 20 to 1. As previously shown, each photobioreactor is a fence-like assembly of vertically oriented tubes. The surface area of the longitudinal sides (the flat sides) versus the ground surface area occupied gives the ratio for the approximate reduction in light intensity. Thus, for a desired illumination intensity, a combination of separation distance and PBR height can be chosen. For instance, a 10 foot tall by 10 foot long PBR at a distance of 2 feet from the nearest PBRs (on either side) would have a surface area of 200 sq. feet (both sides) and would occupy 20 sq. feet of ground surface for a ratio of 10:1. Assuming that the light entering the housing greenhouse light is diffuse and reflected from surfaces, that would give a lighting ratio of 10:1, dropping the average sunlight intensity by a factor of 10. Adjustments to one parameter, such as height, would then require an opposing change in the other parameters, such as separation distance. For instance, a 20% increase in height would increase surface area by 20% as well. In order to maintain the chosen ratio of 10:1, the ground space occupied would have to increase by 20% as well. One such way to achieve such an increase would be increase the separation distance to approximately 2 feet 5 inches.

Similarly, other factors, such as tube diameter, also affect the photobioreactor's parameters. For example, as the tube diameter increases, the volume of culture increases linearly with the increase in cross sectional area. However, as tube diameter increases the maximum density of the culture (at a given light intensity) decreases as light fails to penetrate to the center of the tube. Thus, smaller diameter tubes are preferred for high culture density. Also, as the volume of culture increases, the weight of the photobioreactor and its medium also increases, requiring thicker plastic films for construction of the tubes. Finally, as the diameter of the tube increases, the amount of air necessary to provide stirring and aeration in each tube-column increases linearly with the increase in cross sectional area. Thus, the tube diameter should not be too small, since the increase in maximum culture density is insufficient to make up for the loss in culture volume. Conversely, the tube diameter should not be too large since the resulting loss in culture density, system weight, and efficiency of aeration/stirring bring harsh diminishing returns.

It also should be noted that the factors of turbidity and flow rate are also considered during the selection and optimization of the tube diameter. Turbulence is characterized by swirling vortices in fluids. The range of sizes of these vortices in a turbulent flow is important in that vortices that are smaller than the size of cells suspended in a culture experiencing that turbulence can be damaged (lysed). That is, if the vortices are smaller than the cells in the turbulent flow, then the cells may be torn (ruptured, lysed) by the turbulence. This affect has been documented both empirically and theoretically in the literature and those skilled in the art will appreciate that Kolmogorov gives a mathematical relationship that can be used for flow in a pipe to estimate the size of the micro-eddies in a turbulent flow. Specifically,

$$\frac{L}{η} \sim {( \frac{UL}{v} )}^{3 / 4} = {Re}^{3 / 4}$$

where the size of the largest eddies are given by “L”, the size of the smallest eddies by “n”, “Re” is the Reynolds number based on the large scale flow features, “v” is the viscosity, and the kinetic energy of the flow is proportional to the square of “U”. Furthermore, turbidity in the culture flows can, within certain limits, help to enhance the exchange of dissolved gasses between the medium and the cultured micro-organisms.

TABLE A

| Micro Eddy Size | | | | | | | | | |
|---|---|---|---|---|---|---|---|---|---|
| (micro-meters) | Pipe Diameter (inches) | | | | | | | | |
| Flow Rate (gpm) | 0.5 | 0.75 | 1 | 1.25 | 1.5 | 1.75 | 2 | 2.5 | 3 |
| 0.5 | 27.59 | 38.82 | 81.64 | 236.09 | 888.43 | 4,183.35 | 23,942.81 | 195,848.61 | 2,084,517.18 |
| 1 | 16.41 | 23.08 | 48.54 | 140.38 | 528.26 | 2,487.44 | 14,236.48 | 116,452.28 | 1,239,461.33 |
| 1.5 | 12.11 | 17.03 | 35.81 | 103.57 | 389.75 | 1,835.20 | 10,503.50 | 85,917.09 | 914,459.63 |
| 2 | 9.76 | 13.72 | 28.86 | 83.47 | 314.11 | 1,479.04 | 8,465.06 | 69,242.94 | 736,988.12 |
| 2.5 | 8.25 | 11.61 | 24.41 | 70.61 | 265.70 | 1,251.11 | 7,160.57 | 58,572.40 | 623,416.05 |
| 3 | 7.20 | 10.13 | 21.29 | 61.58 | 231.74 | 1,091.22 | 6,245.42 | 51,086.61 | 543,740.95 |
| 3.5 | 6.41 | 9.02 | 18.97 | 54.86 | 206.44 | 972.08 | 5,563.55 | 45,508.96 | 484,375.26 |
| 4 | 5.80 | 8.16 | 17.16 | 49.63 | 186.77 | 879.44 | 5,033.36 | 41,172.10 | 438,215.76 |
| 4.5 | 5.31 | 7.47 | 15.71 | 45.44 | 170.98 | 805.09 | 4,607.80 | 37,691.08 | 401,165.52 |
| 5 | 4.91 | 6.90 | 14.52 | 41.98 | 157.99 | 743.92 | 4,257.70 | 34,827.35 | 370,685.40 |
| 5.5 | 4.57 | 6.43 | 13.52 | 39.09 | 147.09 | 692.60 | 3,963.97 | 32,424.70 | 345,112.72 |
| 6 | 4.28 | 6.02 | 12.66 | 36.62 | 137.80 | 648.84 | 3,713.55 | 30,376.28 | 323,310.30 |
| 6.5 | 4.03 | 5.67 | 11.92 | 34.48 | 129.77 | 611.04 | 3,497.18 | 28,606.38 | 304,472.42 |
| 7 | 3.81 | 5.36 | 11.26 | 32.62 | 122.75 | 578.00 | 3,308.10 | 27,059.79 | 288,011.25 |
| 7.5 | 3.62 | 5.09 | 10.71 | 30.98 | 116.56 | 548.85 | 3,141.28 | 25,695.20 | 273,487.22 |
| 8 | 3.45 | 4.85 | 10.20 | 29.51 | 111.05 | 522.92 | 2,992.83 | 24,481.08 | 260,564.65 |
| 8.5 | 3.30 | 4.64 | 9.75 | 28.20 | 106.12 | 499.68 | 2,859.82 | 23,392.89 | 248,982.48 |
| 9 | 3.16 | 4.44 | 9.34 | 27.02 | 101.66 | 478.71 | 2,739.81 | 22,411.25 | 238,534.44 |
| 9.5 | 3.03 | 4.27 | 8.97 | 25.94 | 97.62 | 459.68 | 2,630.93 | 21,520.65 | 229,055.27 |
| 10 | 2.92 | 4.10 | 8.63 | 24.96 | 93.94 | 442.34 | 2,531.64 | 20,708.47 | 220,410.86 |
| 10.5 | 2.81 | 3.96 | 8.32 | 24.07 | 90.56 | 426.44 | 2,440.68 | 19,964.39 | 212,491.23 |
| 11 | 2.72 | 3.82 | 8.04 | 23.24 | 87.46 | 411.82 | 2,356.99 | 19,279.84 | 205,205.25 |
| 11.5 | 2.65 | 3.70 | 7.77 | 22.48 | 84.59 | 398.32 | 2,279.71 | 18,647.67 | 198,476.73 |
| 12 | 2.54 | 3.58 | 7.53 | 21.77 | 81.93 | 385.80 | 2,208.09 | 18,061.84 | 192,241.46 |
| 12.5 | 2.47 | 3.47 | 7.30 | 21.12 | 79.46 | 374.17 | 2,141.51 | 17,517.23 | 186,444.88 |
| 13 | 2.40 | 3.37 | 7.09 | 20.50 | 77.16 | 363.32 | 2,079.43 | 17,009.46 | 181,040.39 |
| 13.5 | 2.35 | 3.28 | 6.89 | 19.93 | 75.01 | 353.18 | 2,021.40 | 16,534.75 | 175,987.84 |
| 14 | 2.27 | 3.19 | 6.71 | 19.40 | 72.99 | 343.68 | 1,967.01 | 16,089.85 | 171,252.51 |
| 14.5 | 2.21 | 3.11 | 6.53 | 18.89 | 71.09 | 334.75 | 1,915.92 | 15,571.91 | 166,804.20 |

Table A, reproduced above, shows the average size of micro-eddies per a given flow rate and pipe diameter. The values of table A that denote micro-eddies smaller than the size of the desired cultured micro-organism are those values of flow rates and tube sizes that should be avoided. In other words, those are the values of flow rate and pipe diameter combinations that are not productive, mostly due to turbidity levels great enough to cause harm to the cultured micro-organisms. After considering the other factors such as cost and light penetration, the flow rate and pipe size should be chosen such that the resulting micro-eddy size is greater than the expected size of the cultured micro-organism.

In some implementations, utilizing a light level of 15 to 1, a two (2) inch diameter tube was used. The two inch lay flat tubing was readably available, hence reducing the cost of materials, and resulting in a photobioreactor with an operating weight of approximately 640 pounds. The four (4) inch tubing was considered for implementation but the 4 inch tubing would have resulted in a photobioreactor of approximately 1200 pounds while offering little improvement in production due to light reduction. Likewise a 2-inch lay flat would have almost halved the weight, culture density would at best nearly double (but possibly not due to shorter light path in dense culture) and thus either not affect or reduce total productivity.

One consideration during the selection of tube diameter is the consideration of how deep the diffused light will enter into the culture of a specific species. While variable based upon the specific species, observations show that as the light path lengthens, the maximum culture density drops. In this case, light path is understood to mean the length or distance light must travel from the incident surface to the deepest part of the culture (center of the tube). Alternatively, as the light path shortens, the density increases. But this is not a linear relationship and heavily dependent upon the specific species of organism being grown.

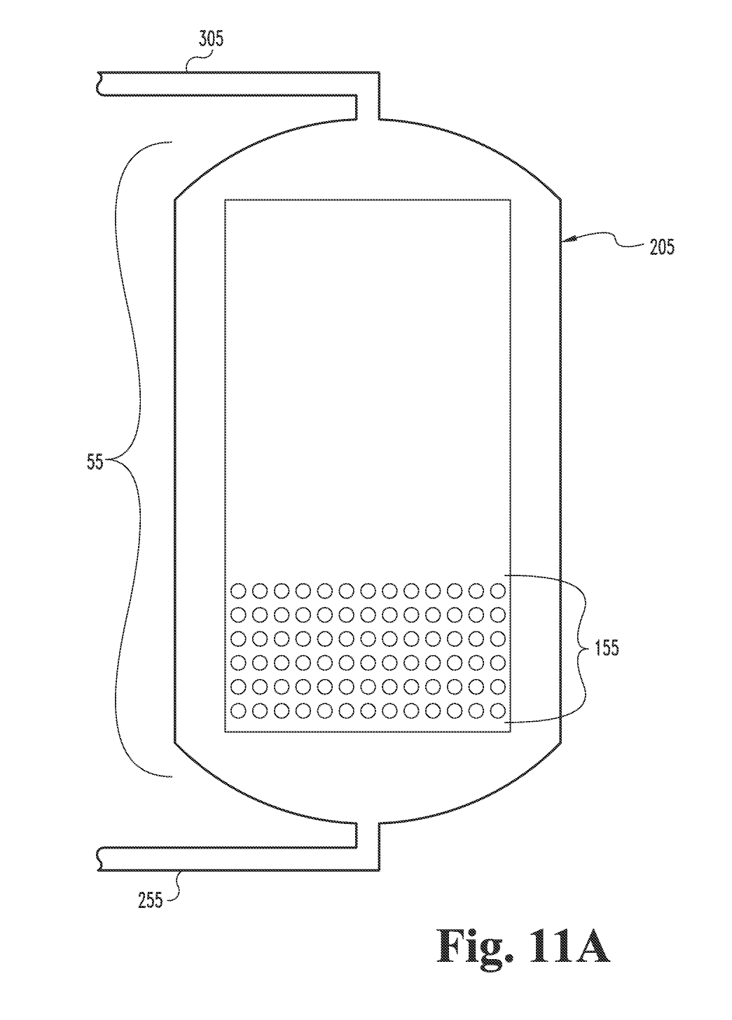

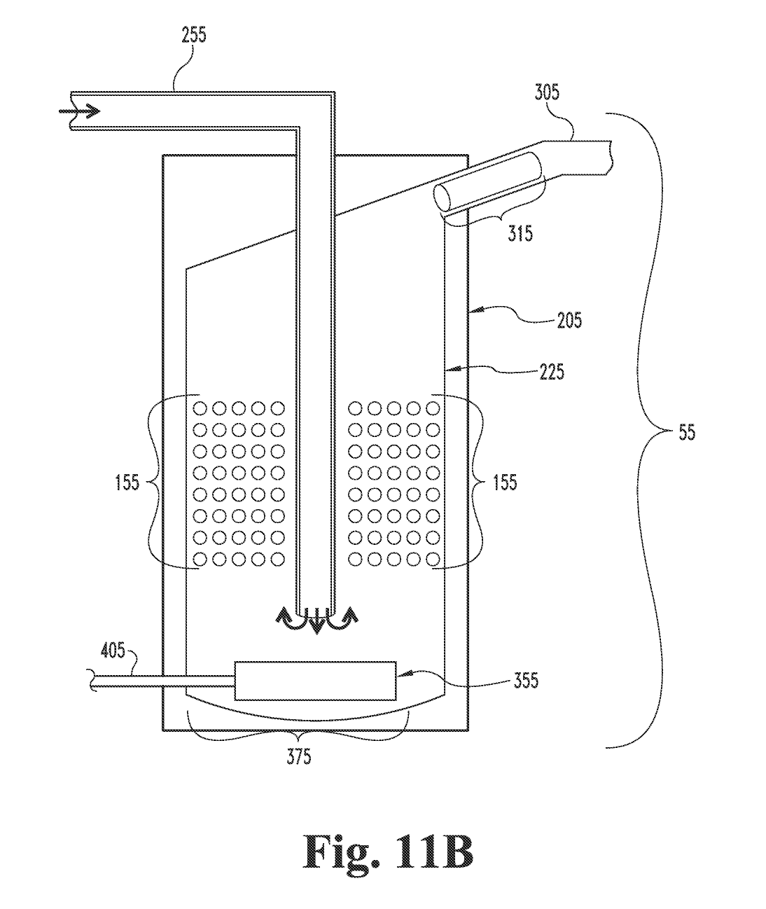

FIG. 11A-11B provide an exemplary novel fluidized bed for biological filtration as part of a photobioreactor such as described in this application, where the exemplary novel fluidized bed for biological filtration utilizes plastic elements constructed or composed from a plastic resin impregnated with one or more bio-active compounds. For the rest of this application, a fluidized bed for biological filtration will be termed “FBB.” Those reasonably skilled in the art will appreciate that such filters (FBB's) possess little or negligible mechanical particle capture ability. As such, they do not clog during use and can be made to not trap a significant portion of microorganisms that are desired to remain in suspension in a supplied media. For example, while a significant problem with other typical filtration systems, because the media bed is fluidized and constantly moving in an FBB, any particles, such as desired and suspended microorganisms, that enter the FBB ultimately pass through without becoming lodged. Further, because the media bed is in constant motion in a fluidized bed filter, all of the media surface area in the filter is used. However, unlike typical biological fluidized bed filters, the use of plastic elements constructed or composed from a plastic resin impregnated with one or more bio-active compounds enables the depicted FBB to utilize both biological processes and anti-microbial actions during the filtration. Further, the plastic elements can be impregnated with one or more bio-active compounds such that the filtration process is highly specific to certain biocontaminents, biocompounds, and microorganisms. For example, the plastic elements can be impregnated with antifungal or antiprotozoan substances such as amphotericin B, a biocide substance targeting the sterols of fungal membranes, as such binding with ergosterol, a component of fungal cell membranes, forming a transmembrane channel that leads to monovalent ion (K+, Na+, H+ and Cl−) leakage. It is believed that the monovalent ion leakage is primarily responsible for cell death. As another example, some implementations have utilized glyphosate (N-(phosphonomethyl)glycine) impregnated plastic spherical elements in the FBB. It should be noted that impregnation of the plastic spherical elements with glyphosate works to limit glyphosate's solubility in water, or medium in this case, and prevents excessive levels of glyphosate in the medium.

FIG. 11 A is a simplified pictorial representation of a FBB 55 utilizing plastic elements 155 constructed or composed from a plastic resin impregnated with one or more bio-active compounds. In this simplified pictorial representation 11 A, the impregnated plastic elements are represented by the bed of spherical elements 155. However, no such limitation upon the shape of the elements or of the housing 205, inlet 255, or outlet 305 should be interpreted from this simplified representation. Further, the housing 205 as well as the inlet 255 or outlet 305 could also be composed from a plastic impregnated with bio active compounds to achieve biological responses such as the promotion of certain microorganisms or the prevention of certain microorganisms. For example, tributyltin, cetylpyridinium chloride, copper sulfate, copper sulphate pentahydrate, thiophanate methyl, or the like could be used to impregnate a plastic used in the housing 205 to inhibit befouling of the housing 205.

However, in some implementations, the outlet 305 also encases a secondary component that is a sterilizing-grade filter 315. A sterilizing grade filter is a filter that produces a sterile discharged through a process of filtering the original fluid or gas through membrane materials and/or porous materials. Such filters literally filter out the offending elements from the original fluid or gas. Because of the filtering action, the contaminants, however, will accumulate near the non-sterile intake portion of the filter. In the case of bio organisms, such accumulation of contaminants eventually serves to provide an environment that is suitable for non-desirable organisms and as such, a sterilizing grade filter will eventually serve to provide a source of contamination. The sterilizing grade filter being contaminated as such is commonly known as bio-fouled. Having the sterilizing-grade filter 315 serve as an outlet of the FBB 55 allows the sterilizing-grade filter 315 to filter out non-living contaminants of the medium, allowing the sterilizing-grade filter 315 to avoid being contaminated or bio-fouled.

FIG. 11 B is a more detailed pictorial representation of an example implementation of a FBB 5 utilizing plastic elements 155 constructed or composed from a plastic resin impregnated with one or more bio-active compounds. FIG. 11 B further includes a pressurized air supply 405, the pressurized air supply 405 being capable of supplying air that is pressurized, flow controlled, and cleansed, and an aeration device 355 causing the supplied air to be diffused into bubbles in the culture. Air flow rate is typically determined by the flow controller of the air supply 405, not depicted. As the bubbles leave the aeration device 355 and travel through plastic elements 155, the air urges the culture to stir and creates turbulence in the respective bed of the plastic elements 155 and to ultimately flow out the outlet 305. The inlet 255 is inverted in respect to the bottom of the cavity 275, which prevents the plastic elements 155 from entering the tube of the inlet 255.

In one implementation, the cavity 225 is substantially cylindrical in shape with a diameter of four (4) inches, a height of ten (10) inches and a bottom portion 375 of the cavity 225 having a shape convex, in nature with respect to the culture. In such implementations, the aeration device 35 is rectangular in shape with approximate dimensions of 3 inch by 0.75 inches by 0.75 inches. In said implementation, the aeration device 355 is separated from the inlet 255 by a distance of three (3) inches. However, it will be appreciated that other shapes and dimensions can be used to construct the FBB. For example, in some implementations the aeration device 355 is hemispherical in shape such that the convex side mates (fits snugly) to the bottom of the cavity 375.

In some implementations, the outlet of the inlet 255 is close enough to the bottom of the cavity 375 such that when culture is exiting the inlet 255, plastic elements 155 will not accumulate between the end of the inlet 255 and the bottom of the cavity 375. The distance will depend upon the size of the filter and upon flow rate.

When culture exits the inlet 255 and enters the cavity 225, it flows upward through the cavity 225 expanding the bed of plastic elements 155. The culture is treated by contacting the plastic elements 155 that are impregnated with one or more biocides. For example, in one implementation of the subject FBB, the plastic elements 155 are impregnated with Cetylpyridinium chloride, copper sulfate and Zinc diethyldithiocarbamate. Cetylpyridinium chloride is a cationic quaternary ammonium that has been shown to be effective in eliminating bacteria and other unwanted microbes. Some implementations utilize cetylpyridinium bromide instead of Cetylpyridinium chloride. Likewise, the copper sulfate and Zinc diethyldithiocarbamate are broad spectrum in their effect and also contribute to the eliminating of unwanted bacterial, mold, and other microbes from the culture.

Those skilled in the art will appreciate that an approach similar to the technique to impregnate the bed of plastic elements 155 with bioactive compounds can be used to impregnate the films used to produce PBRs. For example, while antibiotics, biocides, and ion coatings are commonly used chemical methods to prevent the development of biofilm accumulation upon surfaces, plastic film impregnated with bioactive compounds does not suffer from the same short lived effective lifespan of such coatings and does not suffer the same leaching effects suffered by such coatings.

As an example, consider the use of tributyltin (TBT), as part of a suitable coating, used to inhibit the biofilm accumulation upon the surface of the components of a PBR. TBT has been used as a wood preservation, antifouling pesticide in marine paints, antifungal in textiles and industrial water systems, such as cooling tower and refrigeration water systems, wood pulp and paper mill systems, and even breweries. However, TBT is an extremely toxic substance capable of persistent organic contamination and biomagnification up the food chain. However, impregnating the plastic film with TBT precludes most, if not all, of the leaching of the TBT into the culture while enabling the TBT to prevent bioaccumulation and fouling of the plastic films (tubes). It should be noted that the bioaccumulation and fouling results from microfouling, that is biofilm formation resulting from bacteria and/or mold like organism adhesion.

It will be appreciated that the photobioreactors 5, 50 described herein can be used to grow virtually any desired algae strains. Typically, the selected algae will be one that grows quickly and can provide a relatively high yield of oil. For example, Botryoccus brauni (Bb), Botryoccus sudeticus (Bs), Scenedesmus dimorphus (Sd), Scenedesmus obliquus (So), Nannochloropsis occulata (Nano) and Neochloris oleoabundans (No) are common strains of algae that have been identified as good sources of algae oil. Further, algae strains may be quickly and efficiently grown to yield other byproducts in addition to fuel oil, such as pharmaceuticals, food protein, and the like.

While the disclosed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

We claim:

1. A closed photobioreactor assembly, comprising:
a panel comprising:
an array of equal radius, generally parallel, generally vertical and generally transparent tubes, the tubes having a radius such that for a pre-determined microorganism preferred light intensity level, photosynthesis viable light is available at the center of each tube for an expected maximum culture density for that microorganism;
an air supply operationally connected to the panel and capable of maintaining a positive pressure within the panel;
a water purifier operationally connected to the panel;
a water supply operationally connected to the water purifier,
wherein the tubes of the panel are connected in fluidic communication with each other.

2. The apparatus of claim 1 further comprising:
a pH sensor positioned to measure a pH of a medium contained within the panel; and
an electronic controller operationally connected to the pH sensor, the air supply, the water purifier, and the water supply.

3. The apparatus of claim 1 wherein the panel further comprises:
a first generally horizontal manifold;
a second generally horizontal manifold positioned below the first generally horizontal manifold;
wherein the tubes of the array extend between the first and second horizontal manifolds, and
wherein each respective tube of the panel is connected in fluidic communication with each horizontal manifold.

4. The apparatus of claim 3 wherein the panel is composed of a single-piece bag construction formed from polymer sheets wherein the tubes of the assembly are separated from one another by welds.

5. The apparatus of claim 1 wherein the air supply includes a selectively actuatable CO₂ supply.

6. The apparatus of claim 1 wherein a common diameter of the tubes is such that an estimated size of micro-eddies occurring within the panel are larger than an expected size of a micro-organism cultured within the panel.

7. The apparatus of claim 1 wherein at least one element of the panel is composed of a polymer impregnated with a biocide.

8. The apparatus of claim 1 wherein the water purifier assembly has at least one element that is composed of a polymer impregnated with a biocide.

9. The apparatus of claim 8 wherein the biocide is tributyltin.

10. The apparatus of claim 8 wherein the biocide is copper sulfate.

11. The apparatus of claim 7 wherein the biocide is an antifungal biocide.

12. The apparatus of claim 11 wherein the antifungal biocide is amphotericin B.

13. The apparatus of claim 7 wherein the biocide is glyphosate.

14. A method of orienting a set of photobioreactors, comprising:
determining an area of each photobioreactor of a set of photobioreactors;
determining a range of preferred light intensities for a microorganism to be cultured;
determining an available expected light intensity for an area in which the photobioreactors are to be placed;
determining an amount of placement area for each photobioreactor based upon the surface area of the photobioreactor, the available expected light intensity, and the range of preferred light intensities for the microorganism to be cultured;
arranging each of the photobioreactors such that area allocated to each photobioreactor is equal to the placement area.

15. The method of claim 14 further comprising shading each photobioreactor that is on an edge of the area that the set of photobioreactors occupy.

16. The method of claim 14 wherein the area of each photobioreactor is equal to a photo-active footprint of the photobioreactor.

17. The method of claim 14 further comprising:
determining whether sunlight is a source of light for the area in which the photobioreactors are to be placed;
determining that sunlight is the source of light for the area in which the photobioreactors are to be placed, substantially aligning a longitudinal axis of each photobioreactor in a north-south orientation.
